(19) United States
(12) Patent Application Publication
(10) Pub. No.: US 2025/0393035 A1
(43) Pub. Date: Dec. 25, 2025

(54) NODE AND TERMINAL IN WIRELESS COMMUNICATION SYSTEM AND METHOD PERFORMED BY THE SAME

(71) Applicant: Samsung Electronics Co., Ltd., Suwon-si (KR)

(72) Inventors: Bowen YANG, Beijing (CN); Yanna BAI, Beijing (CN); Peng LIN, Beijing (CN); Di SU, Beijing (CN); Chen QIAN, Beijing (CN)

(21) Appl. No.: 19/212,041

(22) Filed: May 19, 2025

(30) Foreign Application Priority Data
Jun. 21, 2024 (CN) 202410814638.2

(51) Int. Cl. H04W 72/0446; H04L 5/00; H04W 28/22

(52) U.S. Cl. CPC H04W 72/0446; H04L 5/0048; H04W 28/22

(57) ABSTRACT

A method performed by a user equipment (UE) in a wireless communication system is provided. The method includes obtaining first information of a first signal, wherein the first signal is modulated in a time-domain, and wherein the first information includes second information related to a length of the first signal and transmitting the first signal on at least two antenna ports respectively based on the first information, wherein the first signal is transmitted after a preamble or after a midamble.

### CROSS-REFERENCE TO RELATED APPLICATION(S)

This application is based on and claims priority under 35 U.S.C. § 119 (a) of a Chinese patent application number 202410814638.2, filed on Jun. 21, 2024, in the Chinese Intellectual Property Office, the disclosure of which is incorporated by reference herein in its entirety.

### BACKGROUND

### 1. Field

The disclosure relates to a technical field of wireless communication. More particularly, the disclosure relates to a node and a terminal in a wireless communication system and methods performed by the same.

### 2. Description of Related Art

Considering the development of wireless communication from generation to generation, the technologies have been developed mainly for services targeting humans, such as voice calls, multimedia services, and data services. Following the commercialization of 5th-generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th-generation (6G) era, there have been ongoing efforts to develop improved 6G communication systems.

6G communication systems, which are expected to be commercialized around 2030, have various significantly improved metrics compared to the current 5G communication systems. The peak data rate will reach at least 50 Gbit/s, and the user experienced data rate will reach at least 300 Mbit/s, the air-interface latency will be less than 1 ms, and the air-interface reliability will reach 10⁻⁵. In addition to the above basic communication metrics, the 6G communication systems will also have sensing capabilities, AI-related capabilities, better security, better interoperability and better sustainability.

In order for the 6G communication systems to fulfill the above metrics, more advanced air-interface technologies and network technologies need to be developed. The evolution of extreme Multiple Input Multiple Output (extreme MIMO) has been already under consideration, including the use of ultra-large scale antenna arrays, the development and evolution of distributed antenna systems, and the design of MIMO air-interface algorithms assisted by Artificial Intelligence (AI). This technology enables higher spectral efficiency, greater coverage, and precise localization and sensing capabilities. Additionally, technologies that contribute to improve high-frequency band coverage, including metamaterial-based lenses and antennas, new antenna architectures, and reconfigurable intelligent surface (RIS), etc., need to be better evolved and developed.

In order to meet some of newly added functions of the 6G communication systems, new technologies need to be developed in the terms of network energy saving, air-interface security, and network security, meanwhile the feasibility of fusion technologies such as Integrated Sensing and Communication, needs to be studied.

Moreover, in order to improve the spectral efficiency and the overall network performances, the following technologies have been developed for 6G communication systems a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a node and a terminal in a wireless communication system and methods performed by the same.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes obtaining first information of a first signal, wherein the first signal is modulated in a time-domain, and wherein the first information includes second information related to a length of the first signal; and transmitting the first signal on at least two antenna ports respectively based on the first information, wherein the first signal is transmitted after a preamble or after a midamble.

In accordance with an aspect of the disclosure, a user equipment (UE) in a wireless communication system is provided. The UE includes a transceiver configured to transmit and receive signals, and a controller coupled with the transceiver and configured to obtain first information of a first signal, wherein the first signal is modulated in a time-domain, and wherein the first information includes second information related to a length of the first signal, and transmit the first signal on at least two antenna ports respectively based on the first information, wherein the first signal is transmitted after a preamble or after a midamble.

According to an embodiment of the disclosure, the first information further includes third information related to locations of time-domain resources for transmitting the first signal.

According to an embodiment of the disclosure, the second information includes the number of time units occupied by the first signal.

According to an embodiment of the disclosure, the obtaining first information of a time-domain modulated first signal includes receiving first signaling including the first information from a first node, wherein the first signaling includes at least one of broadcast signaling related to Ambient Internet of Things (A-IoT) and user-specific signaling related to A-IoT.

According to an embodiment of the disclosure, the third information includes locations of time units occupied by the first signal.

According to an embodiment of the disclosure, the third information includes seventh information associated with a periodicity of the first signal.

According to an embodiments of the disclosure, the second information includes a value k, and wherein a sequence length of the first signal is equal to 2^{k}, where k is an integer greater than 0.

According to an embodiment of the disclosure, the first information further includes eighth information related to a code rate and ninth information related to a data rate, and wherein the method further includes determining a duration of a time unit occupied by the first signal based on the eighth information and the ninth information.

According to an embodiment of the disclosure, the first signal is a first signal sequence; and wherein a length of the first signal sequence is equal to the number of time units occupied by the first signal and is greater than or equal to the number of ports of the at least two antenna ports.

According to an embodiment of the disclosure, the first signal is a first signal sequence; and wherein the first signal sequence on each antenna port includes Nₐₙₜ sub-sequences, where Nₐₙₜ is the number of ports of the at least two antenna ports, and the first signal sequence on each antenna port is associated with an index of the antenna port.

According to an embodiment of the disclosure, a length of each sub-sequence is

$${L}_{sub} = \frac{{L}_{rs}}{{N}_{ant}} ,$$

where Lᵣₛ is a length of the first signal sequence, and wherein the first signal sequence on each antenna port being associated with an index of the antenna port includes for antenna port i, i∈[0, Nₐₙₜ−1] a sub-sequence i includes one 1 and L_{sub}−1 zeros, and the 1 is located at a start location of the sub-sequence i; and other sub-sequences except the sub-sequence i include L_{sub} zeros.

According to an embodiment of the disclosure, the first signal is a first signal sequence; and wherein the first signal sequence on each antenna port includes a pseudo-random sequence after cyclic shifting of a base sequence, wherein a bit number of the cyclic shifting is associated with an index of the antenna port.

According to an embodiment of the disclosure, the first signal is a first signal sequence; wherein the first signal sequence includes the first Nₐₙₜ rows of an Lᵣₛ-order square matrix, where Lᵣₛ is a length of the first signal sequence and Nₐₙₜ is the number of ports of the at least two antenna ports; and wherein the Lᵣₛ-order square matrix consists of 1 and −1, and any two rows of the Lᵣₛ-order square matrix are orthogonal.

According to an embodiment of the disclosure, the method further includes receiving second signaling including update information of the first signal from a first node, wherein the update information includes at least one of fourth information related to a change value of the number of time units occupied by the first signal and fifth information related to a change value of locations of time-domain resources for transmitting the first signal; and transmitting the first signal on the at least two antenna ports respectively based on the update information.

In accordance with another aspect of the disclosure, a method performed by a first node in a wireless communication system is provided. The method includes transmitting first information of a first signal to a user equipment (UE), wherein the first signal is modulated in a time-domain, and wherein the first information includes second information related to a length of the first signal; and receiving the first signal on at least two antenna ports respectively based on the first information, wherein at least one of the first signals is transmitted after a preamble or after a midamble.

In accordance with another aspect of the disclosure, a first node in a wireless communication system is provided. The first node includes a transceiver configured to transmit and receive signals, and a controller coupled with the transceiver and configured to transmit first information of a first signal to a user equipment (UE), wherein the first signal is modulated in a time-domain, and wherein the first information includes second information related to a length of the first signal, and receive the first signal on at least two antenna ports respectively based on the first information, wherein at least one of the first signals is transmitted after a preamble or after a midamble.

According to an embodiment of the disclosure, the first information further includes third information related to locations of time-domain resources for transmitting the first signal.

According to an embodiment of the disclosure, the second information includes the number of time unit occupied by the first signal.

According to an embodiment of the disclosure, the transmitting first information of a time-domain modulated first signal to a terminal includes transmitting first signaling including the first information to the terminal, wherein the first signaling includes at least one of broadcast signaling related to Ambient Internet of Things (A-IoT) and user-specific signaling related to A-IoT.

According to an embodiment of the disclosure, the third information includes locations of time units occupied by the first signal.

According to an embodiment of the disclosure, the third information includes seventh information associated with a periodicity of the first signal.

According to an embodiment of the disclosure, the second information includes a value k, and wherein a sequence length of the first signal is equal to 2^{k}, where k is an integer greater than 0.

According to an embodiment of the disclosure, the first information further includes eighth information related to a code rate and ninth information related to a data rate, and wherein the method further includes determining a duration of a time unit occupied by the first signal based on the eighth information and the ninth information.

According to an embodiment of the disclosure, the first signal is a first signal sequence; and wherein a length of the first signal sequence is equal to the number of time units included in the first signal and is greater than or equal to the number of ports of the at least two antenna ports.

According to an embodiment of the disclosure, the first signal is a first signal sequence; and wherein the first signal sequence on each antenna port includes Nₐₙₜ sub-sequences, where Nₐₙₜ is the number of ports of the at least two antenna ports, and the first signal sequence on each antenna port is associated with an index of the antenna port.

According to an embodiment of the disclosure, a length of each sub-sequence is

$${L}_{s u b} = \frac{{L}_{r s}}{{N}_{a n t}} ,$$

where Lᵣₛ is a length of the first signal sequence, and wherein the first signal sequence on each antenna port being associated with an index of the antenna port includes for antenna port i, i∈[0, Nₐₙₜ−1] a sub-sequence i includes one 1 and L_{sub}−1 zeros, and the 1 is located at a start location of the sub-sequence i; and other sub-sequences except the sub-sequence i include L_{sub} zeros.

According to an embodiment of the disclosure, the first signal is a first signal sequence; and wherein the first signal sequence on each antenna port includes a pseudo-random sequence after cyclic shifting of a base sequence, wherein a bit number of the cyclic shifting is associated with an index of the antenna port.

According to an embodiment of the disclosure, the first signal is a first signal sequence; wherein the first signal sequence includes the first Nₐₙₜ rows of an Lᵣₛ-order square matrix, where Lᵣₛ is a length of the first signal sequence and Nₐₙₜ is the number of ports of the at least two antenna ports; and wherein the Lᵣₛ-order square matrix consists of 1 and −1, and any two rows of the Lᵣₛ-order square matrix are orthogonal.

According to an embodiment of the disclosure, the method further includes transmitting second signaling including update information of the first signal to the terminal, wherein the update information includes at least one of fourth information related to a change value of the number of time units included in the first signal and fifth information related to a change value of locations of time-domain resources for transmitting the first signal; and receiving the first signal on the at least two antenna ports respectively based on the update information.

Embodiments of the disclosure provide a terminal in a wireless communication system, including a transceiver configured to transmit and receive signals; and a processor coupled to the transceiver and configured to perform methods performed by a terminal in a wireless communication system according to an embodiment of the disclosure.

In accordance with another aspect of the disclosure, a node device in a wireless communication system is provided. The node device includes a transceiver configured to transmit and receive signals; and a processor coupled to the transceiver and configured to perform methods performed by a node device (e.g., a first node, etc.) in a wireless communication system according to an embodiment of the disclosure.

Embodiments of the disclosure provide a computer-readable medium having stored thereon computer-readable instructions, which, when executed by a processor, are used to implement methods performed by any node and/or terminal in a wireless communication system according to an embodiment of the disclosure.

The methods performed by a node and/or a terminal in a wireless communication system provided by the disclosure can effectively enable the node and/or the terminal to perform transmission of reference signals on multi-antenna ports by exchanging reference signals related information related to multi-antenna port transmission between the node and/or the terminal.

Accordingly, the embodiment herein is to provide a method performed by a terminal in a wireless communication system, the method comprises obtaining first information of a time-domain modulated first signal, wherein the first information includes second information related to a length of the first signal; and transmitting the first signal on at least two antenna ports respectively based on the first information. further, at least one of the first signals is transmitted after a preamble or after a midamble.

In an embodiment, the first information further includes third information related to locations of time-domain resources for transmitting the first signal.

In an embodiment, the second information includes the number of time units occupied by the first signal.

In an embodiment, the obtaining first information of a time-domain modulated first signal comprises receiving first signaling including the first information from a first node. Further, the first signaling includes at least one of: broadcast signaling related to Ambient Internet of Things (A-IoT) and user-specific signaling related to A-IoT.

In an embodiment, the third information includes locations of time units occupied by the first signal.

In an embodiment, the third information includes seventh information associated with a periodicity of the first signal.

In an embodiment, the second information includes a value k, and a sequence length of the first signal is equal to 2\hat{ }k, where k is an integer greater than 0.

In an embodiment, the first information further includes eighth information related to a code rate and ninth information related to a data rate. Further, the method further comprises determining a duration of a time unit occupied by the first signal based on the eighth information and the ninth information.

In an embodiment, the first signal is a first signal sequence. Further, a length of the first signal sequence is equal to the number of time units occupied by the first signal and is greater than or equal to the number of ports of the at least two antenna ports.

In an embodiment, the first signal is a first signal sequence and the first signal sequence on each antenna port includes N_ant sub-sequences, where N_ant is the number of ports of the at least two antenna ports, and the first signal sequence on each antenna port is associated with an index of the antenna port.

In an embodiment, a length of each sub-sequence is L_sub=L_rs/N_ant, where L_rs is a length of the first signal sequence. The first signal sequence on each antenna port being associated with an index of the antenna port includes for antenna port i, i∈[0, N_ant−1]: a sub-sequence i includes one 1 and L_sub−1 zeros, and the 1 is located at a start location of the sub-sequence i; and other sub-sequences except the sub-sequence i include L_sub zeros.

In an embodiment, the first signal is a first signal sequence. Further, the first signal sequence on each antenna port includes a pseudo-random sequence after cyclic shifting of a base sequence, wherein a bit number of the cyclic shifting is associated with an index of the antenna port.

In an embodiment, the first signal is a first signal sequence. Further, the first signal sequence includes the first N_ant rows of an L_rs-order square matrix, where L_rs is a length of the first signal sequence and N_ant is the number of ports of the at least two antenna ports. Further, the L_rs-order square matrix consists of 1 and −1, and any two rows of the L_rs-order square matrix are orthogonal.

In an embodiment, the method further comprises: receiving second signaling including update information of the first signal from a first node, wherein the update information includes at least one of fourth information related to a change value of the number of time units occupied by the first signal and fifth information related to a change value of locations of time-domain resources for transmitting the first signal; and transmitting the first signal on the at least two antenna ports respectively based on the update information.

Accordingly, the embodiment herein is to provide a method performed by a first node in a wireless communication system. The method further includes transmitting first information of a time-domain modulated first signal to a terminal, wherein the first information includes second information related to a length of the first signal; and receiving the first signal on at least two antenna ports respectively based on the first information. Further, at least one of the first signals is transmitted after a preamble or after a midamble.

Accordingly, the embodiment herein is to provide 16. A terminal in a wireless communication system. The method includes a transceiver configured to transmit and receive signals; and a controller coupled to the transceiver and configured to perform the method according to method performed by a terminal.

Accordingly, the embodiment herein is to provide a first node in a wireless communication system. The first node comprises a transceiver configured to transmit and receive signals; and a controller coupled to the transceiver and configured to perform the method according to method performed by a terminal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIG. 2 illustrates an example base station according to an embodiment of the disclosure;

FIG. 3 illustrates an example user equipment according to an embodiment of the disclosure;

FIG. 4 illustrates a schematic diagram of signaling exchanging between a first node and an Ambient Internet of Things (A-IoT) device according to an embodiment of the disclosure;

FIG. 5 illustrates a schematic diagram of signaling exchanging between a first node and an Ambient Internet of Things (A-IoT) device according to an embodiment of the disclosure;

FIG. 6A illustrates a schematic diagram of relative time-domain resource locations for reference signal sequence transmission according to an embodiment of the disclosure;

FIG. 6B illustrates a schematic diagram of relative time-domain resource locations for reference signal sequence transmission according to an embodiment of the disclosure;

FIG. 6C illustrates a schematic diagram of relative time-domain resource locations for reference signal sequence transmission according to an embodiment of the disclosure;

FIG. 6D illustrates a schematic diagram of relative time-domain resource locations for reference signal sequence transmission according to an embodiment of the disclosure;

FIG. 7 illustrates a schematic diagram of absolute time-domain resource locations for reference signal sequence transmission according to an embodiment of the disclosure;

FIG. 8 illustrates a schematic diagram of a Nₐₙₜ×Lᵣₛ reference signal block composed of Nₐₙₜ reference signal sequences according to an embodiment of the disclosure;

FIG. 9 illustrates a schematic diagram of durations of a reference signal and a non-reference signal according to an embodiment of the disclosure;

FIG. 10A illustrates a schematic diagram of a reference signal sequence according to an embodiment of the disclosure;

FIG. 10B illustrates a schematic diagram of a reference signal sequence according to an embodiment of the disclosure;

FIG. 11 illustrates a schematic diagram of a 4-order Hadamard matrix and a reference signal block according to an embodiment of the disclosure;

FIG. 12A illustrates a schematic diagrams of signaling exchanging between a first node and an Ambient Internet of Things (A-IoT) device according to an embodiment of the disclosure;

FIG. 12B illustrates a schematic diagrams of signaling exchanging between a first node and an Ambient Internet of Things (A-IoT) device according to an embodiment of the disclosure;

FIG. 13 illustrates a method performed by a terminal in a wireless communication system according to an embodiment of the disclosure;

FIG. 14 illustrates a method performed by a first node in a wireless communication system according to an embodiment of the disclosure;

FIG. 15 illustrates a schematic diagram of a node according to an embodiment of the disclosure; and

FIG. 16 illustrates a schematic diagram of a user equipment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” includes A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The drawings discussed below and various embodiments used to describe the principles of the disclosure in this patent document are for illustration only and should not be construed as limiting the scope of the disclosure in any way. Those skilled in the art will understand that the principles of the disclosure can be implemented in any suitably arranged system or device.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital versatile disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The figures included herein, and the various embodiments used to describe the principles of the disclosure are by way of illustration only and should not be construed in any way to limit the scope of the disclosure. Further, those skilled in the art will understand that the principles of the disclosure may be implemented in any suitably arranged wireless communication system.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

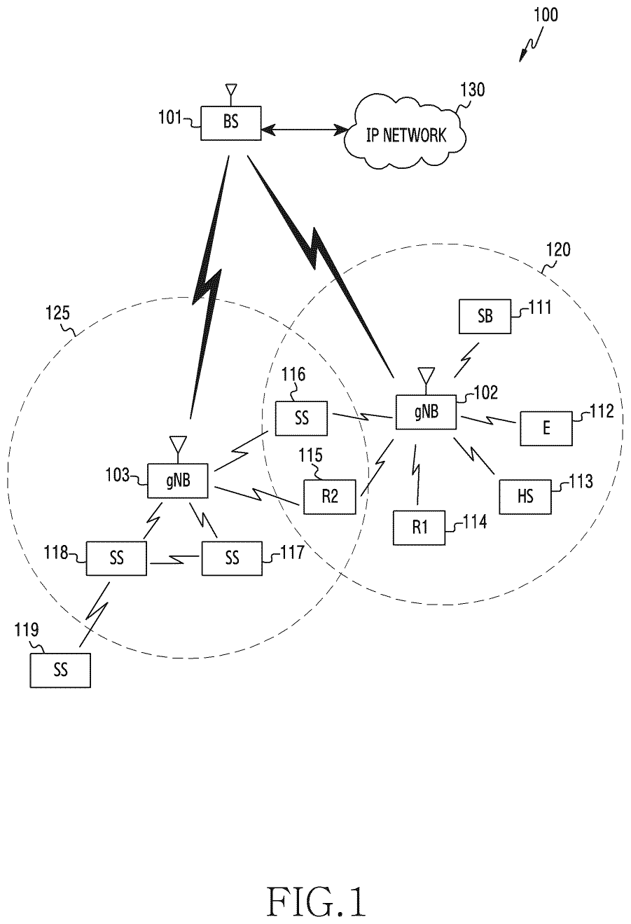

FIGS. 1-3 below describe various embodiments of the disclosure implemented in wireless communications systems. The descriptions of FIGS. 1-3 are not meant to imply physical or architectural limitations to the manner in which different embodiments may be implemented. Different embodiments of the disclosure may be implemented in any suitably-arranged communications system.

FIG. 1 illustrates an example wireless network according to an embodiment of the disclosure. The embodiment of the wireless network shown in FIG. 1 is for illustration only. Other embodiments of the wireless network 100 could be used without departing from the scope of the disclosure.

Referring to FIG. 1, the wireless network includes a base station (next generation nodeB, gNB or gNodeB) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a Wi-Fi hotspot (HS); a UE 114, which may be located in a first residence (R1); a UE 115, which may be located in a second residence (R2); and a UE 116, which may be a mobile device (M), such as a cell phone, a wireless laptop, a wireless personal digital assistant (PDA), or the like. The gNB 103 provides wireless broadband access to the network 130 for a second plurality of UEs within a coverage area 125 of the gNB 103. The second plurality of UEs includes the UE 115 and the UE 116, as well as subscriber stations (SS, for example, UEs) 117, 118 and 119. In some embodiments, one or more of the gNBs 101-103 may communicate with each other and with the UEs 111-116 using existing wireless communication techniques, and one or more of the UE 111-119 may communicate directly with each other (e.g., UEs 117-119) using other existing or proposed wireless communication techniques.

Depending on the network type, the term “base station” or “BS” can refer to any component (or collection of components) configured to provide wireless access to a network, such as transmit point (TP), transmit-receive point (TRP), an enhanced (or “evolved”) base station (eNodeB or eNB), a 5G base station (gNB), a macrocell, a femtocell, a wireless fidelity (Wi-Fi) access point (AP), or other wirelessly enabled devices. Base stations may provide wireless access in accordance with one or more wireless communication protocols, e.g., 3rd Generation Partnership Project (3GPP) 5G New Radio (NR), Long Term Evolution (LTE), LTE Advanced (LTE-A), high speed packet access (HSPA), Wi-Fi 802.11a/b/g/n/ac, etc. For the sake of convenience, the various names for a base station-type apparatus and functionality are used interchangeably in this patent document to refer to network infrastructure components that provide wireless access to remote terminals. Also, depending on the network type, the term “user equipment” (UE) can refer to any component such as a mobile station (MS), subscriber station (SS), remote terminal, wireless terminal, receive point, or user device. For the sake of convenience, the various names for a user equipment-type device and functionality are used interchangeably in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-119 include circuitry, programing, or a combination thereof. In certain embodiments, and one or more of the gNBs 101-103 includes circuitry, programing, or a combination thereof.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

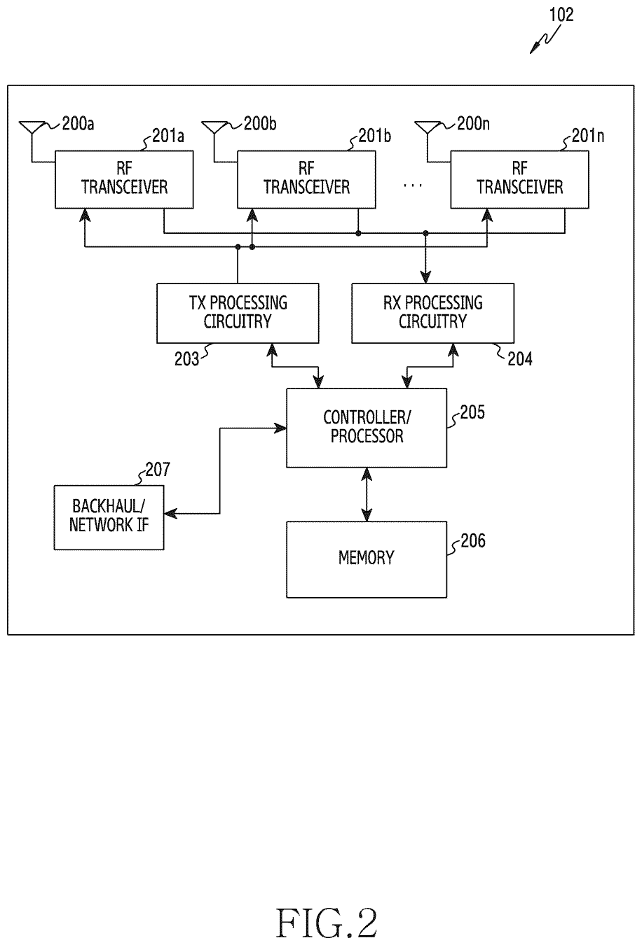

FIG. 2 illustrates an example base station according to an embodiment of the disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the disclosure to any particular implementation of a gNB.

Referring to FIG. 2, the gNB 102 includes multiple antennas 200a-200n, multiple radio frequency (RF) transceivers 201a-201n, transmit (TX) processing circuitry 203, and receive (RX) processing circuitry 204. The gNB 102 also includes a controller/processor 205, a memory 206, and a backhaul or network interface 207.

The RF transceivers 201a-201n receive, from the antennas 200a-200n, incoming RF signals, such as signals transmitted by UEs in the network 100. The RF transceivers 201a-201n down-convert the incoming RF signals to generate intermediate frequency (IF) or baseband signals. The IF or baseband signals are sent to the RX processing circuitry 204, which generates processed baseband signals by filtering, decoding, and/or digitizing the baseband or IF signals. The RX processing circuitry 204 transmits the processed baseband signals to the controller/processor 205 for further processing.

The TX processing circuitry 203 receives analog or digital data (such as voice data, web data, electronic mail, or interactive video game data) from the controller/processor 205. The TX processing circuitry 203 encodes, multiplexes, and/or digitizes the outgoing baseband data to generate processed baseband or IF signals. The RF transceivers 201a-201n receive the outgoing processed baseband or IF signals from the TX processing circuitry 203 and up-converts the baseband or IF signals to RF signals that are transmitted via the antennas 201a-201n.

The controller/processor 205 can include one or more processors or other processing devices that control the overall operation of the gNB 102. For example, the controller/processor 205 could control the reception of forward channel signals and the transmission of reverse channel signals by the RF transceivers 201a-201n, the RX processing circuitry 204, and the TX processing circuitry 203 in accordance with well-known principles. The controller/processor 205 could support additional functions as well, such as more advanced wireless communication functions.

For instance, the controller/processor 205 could support beam forming or directional routing operations in which outgoing signals from multiple antennas 200a-200n are weighted differently to effectively steer the outgoing signals in a desired direction. Any of a wide variety of other functions could be supported in the gNB 102 by the controller/processor 205.

The controller/processor 205 is also capable of executing programs and other processes resident in the memory 206, such as an operating system (OS). The controller/processor 205 can move data into or out of the memory 206 as required by an executing process.

The controller/processor 205 is also coupled to the backhaul or network interface 207. The backhaul or network interface 207 allows the gNB 102 to communicate with other devices or systems over a backhaul connection or over a network. The interface 207 could support communications over any suitable wired or wireless connection(s). For example, when the gNB 102 is implemented as part of a cellular communication system (such as one supporting 5G, LTE, or LTE-A), the interface 207 could allow the gNB 102 to communicate with other gNBs over a wired or wireless backhaul connection. When the gNB 102 is implemented as an access point, the interface 207 could allow the gNB 102 to communicate over a wired or wireless local area network or over a wired or wireless connection to a larger network (such as the Internet). The interface 207 includes any suitable structure supporting communications over a wired or wireless connection, such as an Ethernet or RF transceiver.

The memory 206 is coupled to the controller/processor 205. Part of the memory 206 could include a random access memory (RAM), and another part of the memory 206 could include a Flash memory or other read only memory (ROM).

Although FIG. 2 illustrates one example of gNB 102, various changes may be made to FIG. 2. For example, the gNB 102 could include any number of each component shown in FIG. 2. As a particular example, an access point could include a number of interfaces 207, and the controller/processor 205 could support routing functions to route data between different network addresses. As another particular example, while shown as including a single instance of TX processing circuitry 203 and a single instance of RX processing circuitry 204, the gNB 102 could include multiple instances of each (such as one per RF transceiver). Also, various components in FIG. 2 could be combined, further subdivided, or omitted and additional components could be added according to particular needs.

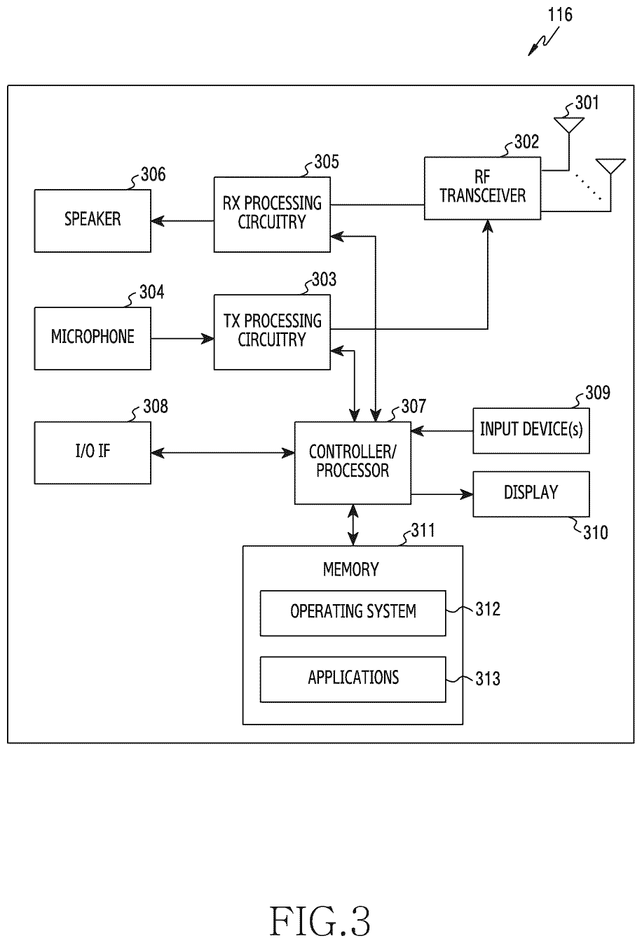

FIG. 3 illustrates an example user equipment according to an embodiment of the disclosure. The embodiment of the UE 116 illustrated in FIG. 3 is for illustration only, and the UEs 111-115 and 117-119 of FIG. 1 could have the same or similar configuration. However, UEs come in a wide variety of configurations, and FIG. 3 does not limit the scope of the disclosure to any particular implementation of a UE.

Referring to FIG. 3, the UE 116 includes an antenna 301, a radio frequency (RF) transceiver 302, TX processing circuitry 303, a microphone 304, and receive (RX) processing circuitry 305. The UE 116 also includes a speaker 306, a controller or processor 307, an input/output (I/O) interface (IF) 308, an input device 309, a touchscreen display 310, and a memory 311. The memory 311 includes an OS 312 and one or more applications 313.

The RF transceiver 302 receives, from the antenna 301, an incoming RF signal transmitted by a gNB of the network 100. The RF transceiver 302 down-converts the incoming RF signal to generate an IF or baseband signal. The IF or baseband signal is sent to the RX processing circuitry 305, which generates a processed baseband signal by filtering, decoding, and/or digitizing the baseband or IF signal. The RX processing circuitry 305 transmits the processed baseband signal to the speaker 306 (such as for voice data) or to the processor 307 for further processing (such as for web browsing data).

The TX processing circuitry 303 receives analog or digital voice data from the microphone 304 or other outgoing baseband data (such as web data, e-mail, or interactive video game data) from the processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal to an RF signal that is transmitted via the antenna 301.

The processor 307 can include one or more processors or other processing devices and execute the OS 312 stored in the memory 311 in order to control the overall operation of the UE 116. For example, the processor 307 could control the reception of forward channel signals and the transmission of reverse channel signals by the RF transceiver 302, the RX processing circuitry 305, and the TX processing circuitry 303 in accordance with well-known principles. In some embodiments, the processor 307 includes at least one microprocessor or microcontroller.

The processor 307 is also capable of executing other processes and programs resident in the memory 311, such as processes for channel state information (CSI) reporting on uplink channel. The processor 307 can move data into or out of the memory 311 as required by an executing process. In some embodiments, the processor 307 is configured to execute the applications 313 based on the OS 312 or in response to signals received from gNBs or an operator. The processor 307 is also coupled to the I/O interface 308, which provides the UE 116 with the ability to connect to other devices, such as laptop computers and handheld computers. The I/O interface 308 is the communication path between these accessories and the processor 307.

The processor 307 is also coupled to the touchscreen display 310. The user of the UE 116 can use the touchscreen display 310 to enter data into the UE 116. The touchscreen display 310 may be a liquid crystal display, light emitting diode display, or other display capable of rendering text and/or at least limited graphics, such as from web sites.

The memory 311 is coupled to the processor 307. Part of the memory 311 could include RAM, and another part of the memory 311 could include a Flash memory or other ROM.

Although FIG. 3 illustrates one example of UE 116, various changes may be made to FIG. 3. For example, various components in FIG. 3 could be combined, further subdivided, or omitted and additional components could be added according to particular needs. As a particular example, the processor 307 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

Embodiments of the disclosure are further described below with reference to the drawings.

The text and drawings are provided as examples only to help understanding the disclosure. They should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

Multi-antenna technology can greatly improve the performance of a wireless communication system. In the most widely used communication systems at present, such as 4G communication systems (e.g., LTE and LTE-A based on 3GPP protocol), 5G communication systems, and 6G communication systems that have been discussed, multi-antenna technology is indispensable.

Different from a communication system based on the 3GPP protocol, an Radio Frequency Identification (RFID) system achieves the goal of identifying a target through non-contact data communication between a reader (which acts like a base station in the communication system) and a Tag (which acts like a terminal in the communication system). RFID is a key technology of Internet of Things (IoT), which is widely used in many industries. However, a typical communication distance of RFID is less than 10 meters. In this case, the channel environment thereof is relatively simple and can be regarded as a single-path channel with only one strong and straight path. Such a channel, which lacks multipath components, does not have enough spatial freedom, thus it cannot support the use of multi-antenna technology.

It is worth noting that a device, which is merely equipped with multiple antennas but cannot use these antennas for space diversity and/or space multiplexing, is not considered to have the multi-antenna technology. For example, at present, there are RFID devices equipped with two antennas, where different antennas are used to receive/transmit signals in different operation frequency bands, which cannot generate a multi-antenna diversity or multiplexing gain. Therefore, such RFID devices cannot be called as having the multi-antenna technology.

In comparison, A-IoT (ambient IoT) is a new Internet of Things technology based on a cellular network. It performs non-contact data communication with an A-IoT device (or A-IoT Tag) through a network node (such as a mobile phone, computer and other user equipment, as well as a base station and transmission/reception point (TRP), etc.) in the cellular network. The scenes A-IoT targets for, such as smart factories and smart warehouses, have a requirement of large coverage, requiring the A-IoT device to have a communication distance of tens to hundreds of meters. In this case, the channel can be regarded as a multipath channel with enough spatial freedom, which can support the application of multi-antenna technology. Meanwhile, due to the improvement of communication distance, an A-IoT system also needs the gain provided by multi-antenna technology to ensure reliable communication quality. Therefore, multi-antenna technology is very important for A-IoT devices to achieve a required communication performance.

Obtaining channel information of different antennas/antenna ports is the premise of applying multi-antenna technology, and the most direct and effective way to obtain the channel information is to perform channel estimation through a reference signal in the received signals. However, in the current A-IoT system, there is no reference signal design for multi-antenna ports.

Due to the differences in equipment complexity, signal processing flow and communication protocol, the reference signal design in traditional cellular communication systems such as 4G LTE and 5G NR cannot be applied to A-IoT systems. In order to simplify the expression, 5G NR is described below as an example of a traditional cellular communication system. Firstly, A-IoT Tags usually have extremely low power consumption and complexity, so they cannot perform complex signal processing such as Fast Fourier Transform (FFT). However, signals of an NR system are generated in frequency domain based on Fast Fourier Transform. Therefore, the A-IoT Tag cannot generate a reference signal in the NR system.

Secondly, data signals and reference signals of an NR system are distributed on a time-frequency resource grid with a granularity of resource element (RE). However, A-IoT signals are only distributed in the time-domain, and the granularity of resources is also different from that of the NR system. Therefore, configuration information for configuring the generation of reference signals and for configuring physical resources used in the NR system cannot be applied to A-IoT.

Furthermore, the uplink reference signal of an NR system generally has a complicated configuration process. However, the A-IoT system adopts a very simple signaling exchanging process which is completely different from that adopted by the NR system. Therefore, the reference signal configuration process of an A-IoT system also needs to be designed in a targeted manner.

Hereinafter, embodiments of the disclosure will be described with a “reference signal” as an example. More generally, the embodiments of the disclosure can also be applied to a first signal, where the first signal may be any other existing or future signal and/or channel including the reference signal. In addition, the naming of “reference signal” in the embodiments of the disclosure is only exemplary. Depending on the application scenario, the “reference signal” in the embodiments of the disclosure may also have any other appropriate name, which is not limited here.

Herein, more generally, the first signal may be a time-domain modulated signal. Time-domain modulation may be such a signal processing technology, which realizes the transmission of information by changing the distribution of signals in time. The basic principle of time-domain modulation is to map information bits (for example, 1 or 0) to be transmitted to different time-domain waveforms. For example, in an on-off-keying (OOK) modulation, information bits are mapped onto carriers with different amplitudes; and in a BPSK modulation, information bits are mapped onto carriers of different phases.

Herein, multi-antenna ports may refer to at least two antenna ports.

Herein, user equipment (UE) may also be used interchangeably with user and terminal, and the like.

Herein, more generally, configuration information may also be called information. For example, “configuration information for a first signal” may also be used interchangeably with “information related to a first signal” or “information for a first signal” and is not limited to information used for configuration.

Herein, a reference signal may refer to a single reference signal, may refer to or include a reference signal sequence (for example, a reference signal sequence transmitted on one antenna port), or may refer to or include a reference signal block (for example, a signal block including one or more reference signal sequences transmitted on one or more antenna ports, respectively). For example, when a reference signal refers to a single reference signal, the reference signal may occupy one time unit in the time-domain; and when a reference signal refers to a reference signal sequence, each single reference signal in the reference signal sequence may occupy one time unit.

In order to optimize the communication system and solve or improve one or more existing problems, embodiments of the disclosure provide a method performed by a multi-antenna A-IoT device. Based on the schemes provided by the embodiments of the disclosure, the A-IoT device may transmit reference signals of not less than two antenna ports according to reference signal configuration information (for example, it may be called first information herein) associated with the transmission of reference signals on multiple antenna ports (for example, in a configured sequence length, on configured resources, etc.), so that the A-IoT system can utilize the multi-antenna technology to improve performance.

For example, a method performed by a multi-antenna A-IoT device may include obtaining and/or determining reference signal configuration information; and transmitting at least one reference signal block or reference signal sequence on at least two antenna ports according to the reference signal configuration information. Alternatively, the method may further include determining reference signal configuration update information. Alternatively, the method may further include transmitting reference signals according to the updated reference signal configuration information.

The method for determining the reference signal configuration information by the A-IoT device may be that: receiving a first signaling from a first node; and determining reference signal configuration information according to the received first signaling. For example, the first signaling may include the reference signal configuration information. Herein, the first signaling may be transmitted by a first node in the communication system, which may be any electronic device, including but not limited to a user equipment, a base station or a device acting as a base station, such as a Relay, etc. For convenience of description, hereinafter, the channel in which the A-IoT device transmit signals to the first node is called a Physical Device to Reader Channel (PDRCH), and the channel in which the first node transmits signals to the A-IoT device is called a Physical Reader to Device Channel (PRDCH).

The first signaling may be a first broadcast signaling (for example, a broadcast signaling related to Ambient Internet of Things (A-IoT)) on the PRDCH channel in the A-IoT system, which may include at least one of the following: an initial broadcast signaling for triggering an A-IoT service, such as a Query signaling in the RFID system; and a subsequent broadcast signaling that updates or adjusts the initial broadcast signaling, such as a QueryRep signaling or a QueryAdjust signaling in the RFID system.

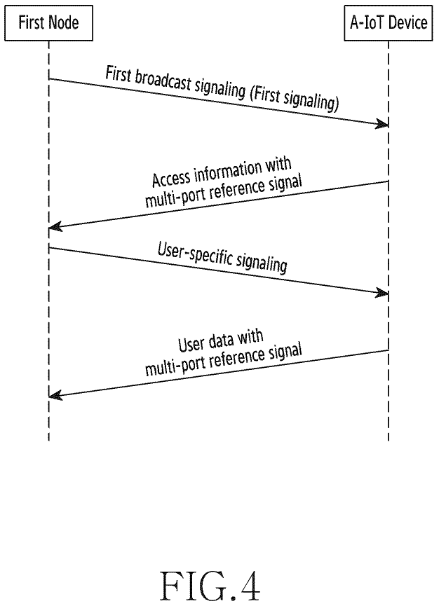

FIG. 4 illustrates a schematic diagram of signaling exchanging between a first node and an Ambient Internet of Things (A-IoT) device according to an embodiment of the disclosure.

Referring to FIG. 4, in this case, all A-IoT devices that successfully receive the signaling can configure, generate and/or transmit reference signals according to the reference signal configuration information contained in the signaling. For an A-IoT system, an A-IoT device generally accesses the system by responding to the broadcast signaling. For example, the A-IoT device transmits access information to the first node after successfully receiving the broadcast signaling. The access information here may be the identification (ID) information of the A-IoT device or a randomly generated access sequence, such as RN16 in the RFID system, etc. Carrying the configuration information for multi-port reference signals in the first broadcast signaling can enable the A-IoT device to transmit access information on multiple antenna ports, which brings better access performance. For example, The A-IoT device may transmit independently generated random access signals on each antenna port, which can greatly reduce the probability that different A-IoT devices generate the same access signal, thus reducing the probability of collision when A-IoT devices perform access, and improving access efficiency. For another example, the A-IoT device may transmit the same access signal on all antenna ports. Due to the gain brought by multiple antennas, the access signal transmitted by the A-IoT device can be received by network nodes farther away, thus improving the coverage of the system.

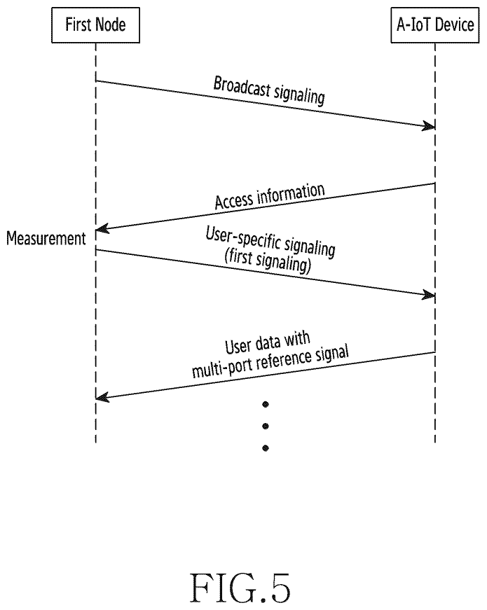

FIG. 5 illustrates a schematic diagram of signaling exchanging between a first node and an Ambient Internet of Things (A-IoT) device according to an embodiment of the disclosure.

Alternatively, the first signaling may also be a user-specific signaling (for example, a user-specific signaling related to Ambient Internet of Things (A-IoT)) on the PRDCH channel in the A-IoT system, such as an Acknowledgement (ACK) signaling and the like in the RFID system, referring to FIG. 5. Since a user-specific signaling can only be successfully received by a specific user, only the A-IoT device that successfully receive the signaling can configure, generate and/or transmit reference signals according to the reference signal configuration information contained in the signaling. In this way, the multi-port reference signal can be configured only for users in need, thus avoiding unnecessary resource overhead. For example, users who need to transmit a large amount of uplink data can be configured with multi-port reference signals.

The first signaling may include information related to a reference signal on at least two antenna ports (i.e., reference signal configuration information). Herein, the information related to the reference signal may include at least one of the following: second information related to a sequence length of the reference signal (for example, reference signal sequence length indication and/or information), third information related to locations of time-domain resources for transmitting the reference signal (for example, reference signal resource indication and/or information), and the like. When the reference signal refers to a reference signal sequence, the second information related to the sequence length of the reference signal may also be referred to as second information related to a length of the reference signal, and may include the number of time units occupied by the reference signal, which will be described in more detail below. The locations of the time-domain resources may be the locations of the time units occupied by the reference signal. In some embodiments, a time unit may be one or more symbols or part of a symbol. In other embodiments, the time unit may also be any time unit or part thereof involved in any existing or future communication system, such as one or more frames, slots, etc. The A-IoT device may determine the length of the reference signal sequence transmitted on at least two antenna ports according to the reference signal sequence length indication, and may also determine the locations of time-domain resources for transmitting the reference signal sequence on at least two antenna ports according to the reference signal resource indication. Different antenna ports may share a set of reference signal configuration information. The design that different antenna ports share a set of reference signal configuration information can enable the A-IoT device to transmit reference signals of different antenna ports on the same time-domain resources, thus avoiding the collision between reference signals and other signals (such as access signals and data signals, etc.) on different antenna ports and affecting the detection of reference signals and other signals. In this way, the resource overhead of the reference signal configuration information can be minimized, and these resource overhead will not be increased due to the increase in the number of antenna ports on which reference signals need to be transmitted.

The reference signal resource indication may be composed of n₁ (n₁≥1) binary bits, which is used to indicate the A-IoT device to transmit a reference signal sequence in one of 2ⁿ¹ resource sets. For example, the second information related to the sequence length of the reference signal may include a first value represented by n₁ (n₁≥1) binary bits, which is used to indicate the A-IoT device to transmit the reference signal sequence in one of the one or more (e.g., 2ⁿ¹)) resource sets corresponding to the first value. The resource set may be a predefined or pre-configured set of time-domain resources. The resource set may be composed of a series of relative time-domain resources, such as one or more of the following: start time-domain resource, start symbol, middle time-domain resource, middle symbol, end time-domain resource, end symbol, etc. Herein, relative time-domain resources may refer to time-domain resources identified by relative time-domain resource locations or indexes instead of absolute time-domain resource locations or indexes. For example, the above-mentioned “start time-domain resource” may refer to one or more time-domain resources starting from the first time-domain resource location in a certain channel and/or signal (e.g., PDRCH channel); the “start symbol” may refer to one or more symbols starting from the first symbol in a certain channel and/or signal; the “middle time-domain resource” may refer to one or more time-domain resources starting from any certain middle location in a certain channel and/or signal; and the “end time-domain resource” may refer to one or more time-domain resources from any certain location in a certain channel and/or signal to the last time-domain resource location in the certain channel and/or signal, and so on.

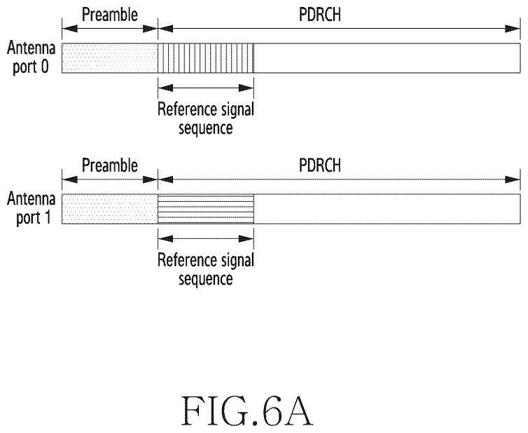

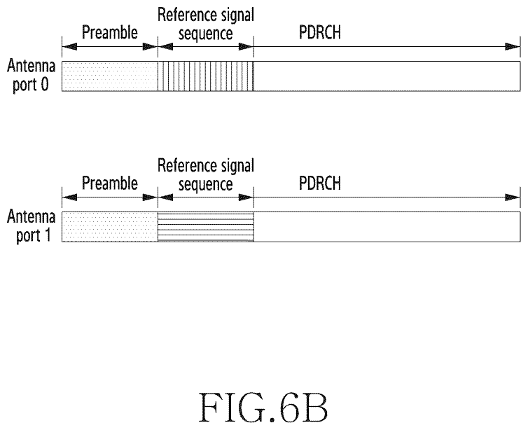

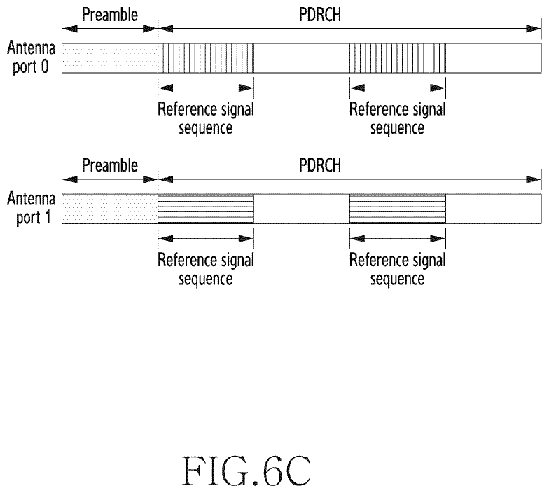

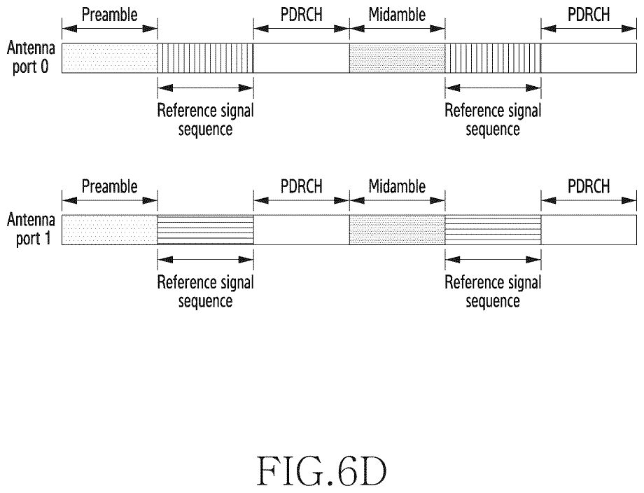

FIGS. 6A to 6D illustrate the relative time-domain resources by taking a case where there are two antenna ports and n₁=1 as an example.

Specifically, FIG. 6A illustrates a schematic diagram of resource set 0 indicated by bit ‘0’ when the reference signal sequence is regarded as a part of PDRCH according to an embodiment of the disclosure.

FIG. 6B illustrates a schematic diagram of resource set 0 indicated by bit ‘0’ when the reference signal sequence is not regarded as a part of PDRCH according to an embodiment of the disclosure.

FIG. 6C illustrates a schematic diagram of resource set 1 indicated by bit ‘1’ when the reference signal sequence is regarded as a part of PDRCH according to an embodiment of the disclosure.

FIG. 6D illustrates a schematic diagram of resource set 1 indicated by bit ‘1’ when the reference signal sequence is not regarded as a part of PDRCH according to an embodiment of the disclosure.

Assume that bit ‘0’ (i.e., the first value is 0) indicates a resource set 0, which only includes a start time-domain resource/start symbol of the signal; and bit ‘1’ (i.e., the first value is 1) indicates a resource set 1, which includes a start time-domain resource and a middle time-domain resource of the signal. In this case, the bit ‘0’ may indicate that the reference signal sequence is transmitted only at a start location of the signal, or it may be said that it is transmitted only at a start location of the PDRCH channel, referring to FIG. 6A; and bit ‘1’ may indicate that the reference signal sequence is transmitted at a start location and a middle location of the signal, or it may be said that it is transmitted at a start location and a middle location of the PDRCH channel, referring to FIG. 6C. It should be noted here that generally, the A-IoT device will transmit a preamble in front of the PDRCH to help the first node communicating with it to perform signal synchronization or clock calibration, etc. It should be noted that the A-IoT device may transmit a preamble on any single antenna port, or transmit the same preamble on at least two antenna ports. In this case, for convenience of description, the reference signal sequence may not be regarded as a part of PDRCH (or PDRCH may be regarded as including only non-reference signals such as control signals and data signals, etc.). Therefore, in case that the reference signal sequence is not regarded as a part of PDRCH, it may also be said that the resource set 0 indicated by bit ‘0’ indicates that the reference signal sequence is only transmitted between the preamble and PDRCH, referring to FIG. 6B. Similarly, the A-IoT device may transmit a midamble at any certain middle location of PDRCH. Therefore, in case that the reference signal sequence is not regarded as a part of PDRCH, it may also be said that the resource set 1 indicated by bit ‘1’ indicates that the reference signal sequence is transmitted between the preamble and/or midamble and PDRCH, referring to FIG. 6D. It should also be noted that although not all cases are shown in FIGS. 6A to 6D, one or more of the preamble, the midamble, and the reference signal sequence may also be regarded as all transmitted in the PDRCH channel, or one or more of the preamble, the midamble, and the reference signal sequence may also be regarded as not transmitted in the PDRCH channel, as long as their relative resource locations meet the example order shown in the drawings. In this case, the A-IoT device may also determine the timing relationship between different signals according to the above reference signal resource indication.

Alternatively, the resource set may consist of a series of absolute time-domain resources. Herein, absolute time-domain resources may refer to time-domain resources identified by absolute time-domain resource locations or indexes, such as time-domain symbols i₁˜ iₙ.

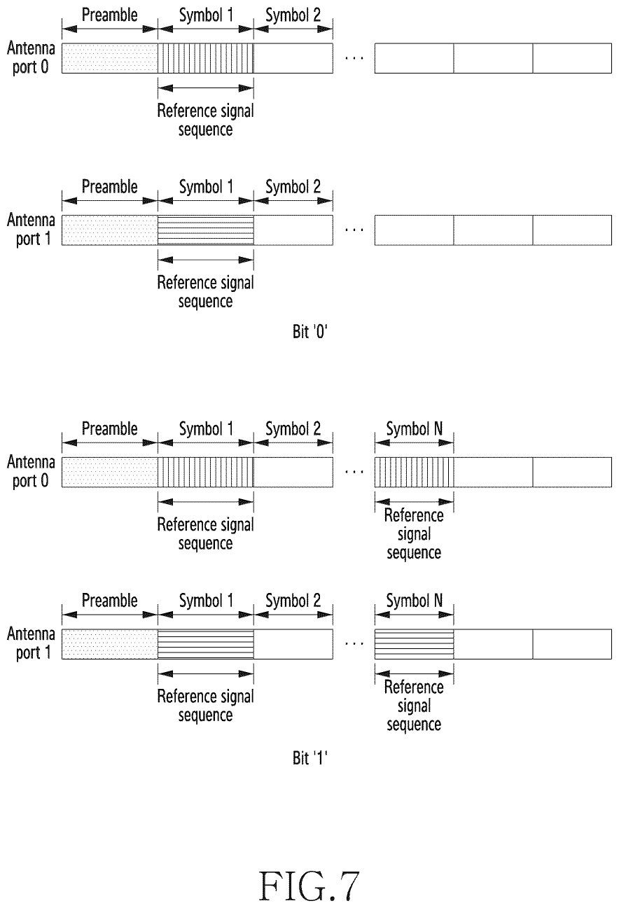

FIG. 7 illustrates a schematic diagram of absolute time-domain resource locations for reference signal sequence transmission according to an embodiment of the disclosure.

Taking FIG. 7 as an example, the bit ‘0’ indicates a resource set 0, and the resource set 0 only includes the first time-domain symbol. Therefore, when the reference signal resource indication is bit ‘0’, it means that the A-IoT device only transmits a reference signal at the first symbol location on the PDRCH. Accordingly, bit ‘1’ indicates a resource set 1, which includes the first and N-th time-domain symbols. Therefore, when the reference signal resource indication is bit ‘1’, it means that the A-IoT device transmits reference signals at the first symbol location and the N-th symbol location on the PDRCH. Herein, N may be any one or more positive integers not greater than the length L of the PDRCH, where L represents the number of time-domain symbols in the PDRCH. An example of N may be that when L is an odd number, the resource set 1 includes the first and the ((N+1)/2)-th time-domain symbols; and when L is an even number, the resource set 1 includes the first and the (N/2)-th time-domain symbols. It should be noted that the first symbol of the PDRCH is behind the preamble, and if there is a midamble, the N-th symbol may be behind the midamble. In other embodiments, the N-th symbol may also precede the midamble.

Alternatively, the reference signal resource information may further include seventh information associated with a periodicity of the reference signals (e.g., a density of the reference signals, a distance between the reference signals, etc.). For example, the reference signal resource indication may also indicate a density p of the reference signal sequences transmitted by the A-IoT device, or a distance d between the reference signal sequences. For example, the second information related to the sequence length of the reference signal may include a second value, which is used for indicating the density or distance of the reference signal sequences transmitted by the A-IoT device on one or more of a plurality of antenna ports. For example, ρ=3 indicates that the density of the reference signal sequence is 3, where the A-IoT device needs to transmit a reference signal sequence on the first symbol and the 1st symbol of every three consecutive symbols from the fourth symbol (that is, it may indicate that the A-IoT device needs to transmit a reference signal sequence on the 1st, 4th, 7th, 10th . . . symbols, etc.); or, d=3 indicates that the interval of the reference signal sequence is 3, where A-IoT device needs to transmit a reference signal sequence on the first symbol and after every three consecutive symbols (that is, it may indicate that the A-IoT device needs to transmit a reference signal sequence on the 1st, 4th, 7th, 10th . . . symbols, etc.).

The reference signal sequence length indication may be composed of n₂ (n₂≥1) binary bits, which is used to indicate the A-IoT device to generate a reference signal sequence with the length of Lᵣₛ=2ⁱ, where i may be defined as an integer in the range of [1, 2ⁿ^{₂}]. For example, the third information related to the locations of the time-domain resources used for transmitting the reference signals may include a third value i (which may also be represented by any other identifier such as k, j, etc.), which is used to indicate the A-IoT device to generate a reference signal sequence with the length of Lᵣₛ=2ⁱ, where i may be an integer greater than 0. For example, in the case that i is represented by n₂ (n₂>1) binary bits, i may be an integer in the range of [1, 2ⁿ^{₂}]. For example, when n₂=3, assume that the length of the reference signal sequence is [1 0 0], which means i=4, so the A-IoT device needs to generate a reference signal sequence with a length of Lᵣₛ=2⁴=16. This design (indication by an exponent) can indicate a larger length range through a small number of binary bits. Alternatively, the reference signal sequence length indication may also be composed of n₃ (n₃≥1) binary bits, which is used to indicate the A-IoT device to generate a reference signal sequence with a length of Lᵣₛ=2˜2ⁿ^{₃}. For example, the third information related to the locations of the time-domain resources used for transmitting the reference signals may include a fourth value, which is used to indicate the A-IoT device to generate a reference signal sequence with a length of the fourth value, where the fourth value may be an integer greater than 1, for example, in the case that the fourth value is represented by n₃ (n₃≥1) binary bits, the fourth value may be an integer in the range of 2˜2ⁿ^{₃}. For example, when n₃=3, assuming that the length of the reference signal sequence is [1 0 0], it means that the A-IoT device needs to generate a reference signal sequence with the length of Lᵣₛ=4. This design (by direct indication) can accurately configure the length of the reference signal sequence with granularity of 1.

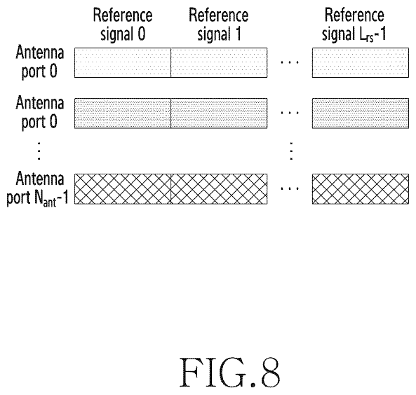

FIG. 8 illustrates a schematic diagram of a Nₐₙₜ×Lᵣₛ reference signal block composed of Nₐₙₜ reference signal sequences according to an embodiment of the disclosure.

Because the reference signal sequence on each antenna port occupies the same time-domain resources, the Nₐₙₜ reference signal sequences transmitted by the A-IoT device of Nₐₙₜ antenna ports at the same time-domain locations form a Nₐₙₜ×Lᵣₛ reference signal block, referring to FIG. 8. Herein, the i-th row represents the reference signal sequence Sᵢ₋₁ transmitted by the antenna port i−1, which consists of Lᵣₛ reference signals that are continuous in time-domain, and any two rows of reference signal sequences Sᵢ and Sⱼ are orthogonal to each other or have low cross-correlation, where ∀i, j∈[0, Nₐₙₜ−1] and i≠j. The “orthogonal to each other” here means that the inner product of Sᵢ and Sⱼ is 0, and the “low cross-correlation” may mean that the inner product of Sᵢ and Sⱼ is less than the sequence length. Specifically, the greater the degree that the inner product of Sᵢ and Sⱼ is less than the sequence length, the lower the cross-correlation between Sᵢ and Sⱼ.

In the reference signal block, the duration Tᵣₛ of each reference signal (that is, the duration of the time unit of the reference signal sequence) is related to one or more of the code rate R_{code} and the data rate R_{data} of the linear code configured for the A-IoT device. More specifically,

$${T}_{r s} = \frac{k \cdot {R}_{c o d e}}{{R}_{d a t a}} ,$$

where k is a predefined positive integer, and it satisfies

$$\frac{1}{{R}_{c o d e}} \geq k \geq 1 .$$

In the signals transmitted by the A-IoT device, the duration of each non-reference signal symbol is

$${T}_{n r s} = \frac{1}{{R}_{d a t a}} ,$$

which contains

$$\frac{1}{{R}_{code}}$$

code chip. This design enables A-IoT devices to generate reference signal sequences and non-reference signals at the same modulation frequency, which is very important for low-end A-IoT devices with limited power consumption. In this case, when k=1, Tᵣₛ is the chip length of the signal transmitted by the A-IoT device, which can make the A-IoT device transmit the longest reference signal sequence within the duration of the reference signal sequence, that is, Lᵣₛ= [symbol] max (L [symbol] ᵣₛ), thus increasing the resolution of the receiver to obtain channel information; and when

$$k = \frac{1}{{R}_{c o d e}} ,$$

Tᵣₛ is the symbol length of the signal transmitted by the A-IoT device, which can make the A-IoT device transmit the longest reference signal, that is, Tᵣₛ= [symbol] max (T [symbol] ᵣₛ), thus improving the accuracy of channel estimation and reducing the error of channel information obtained by the receiver.

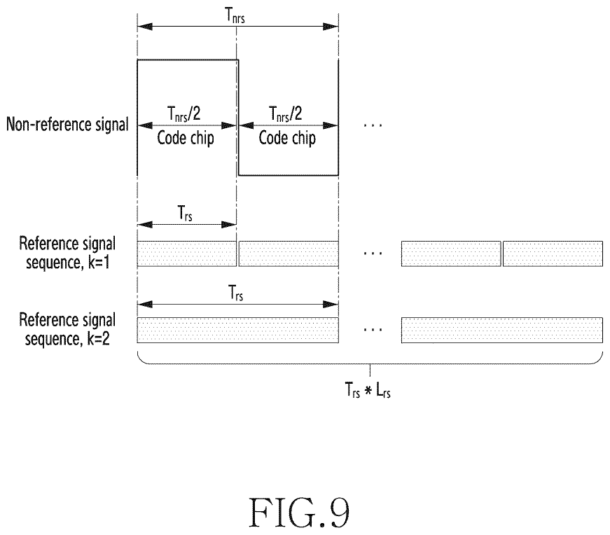

FIG. 9 illustrates a schematic diagram of durations of a reference signal and a non-reference signal according to an embodiment of the disclosure.

Referring to FIG. 9, the A-IoT device adopts OOK modulation and a linear code with a code rate of 1/2. A non-reference signal symbol in the figure contains two chips, that is, one “high” chip and one “low” chip (corresponding to ‘On’ and ‘Off’ in OOK modulation respectively). When k=1,

$${T}_{r s} = \frac{1 \cdot \frac{1}{2}}{{R}_{d a t a}} = \frac{1}{2} {T}_{n r s} ;$$

and when k=2,

$${T}_{r s} = \frac{2 \cdot \frac{1}{2}}{{R}_{d a t a}} = {T}_{n r s} .$$

The code rate R_{code} of the linear code may be determined according to the information related to the code rate transmitted by the first node. Herein, the information related to the code rate may be or include the code rate R_{code} itself, and 1≥ R_{code}>0. When R_{code}=1, it means not to perform encoding, or to perform encoding with a code rate of 1 such as a Return to Zero (RZ) encoding or a Non-Return to Zero (NRZ) encoding. Alternatively, the information related to the code rate may be the number of subcarrier periods (or the order of subcarrier modulation) M within each symbol. In this case, the code rate is

$${R}_{c o d e} = \frac{1}{2 M} .$$

The data rate R_{data} may be determined according to the information related to the data rate transmitted by the first node. Herein, the information related to the data rate may be or include the data rate R_{data} itself. Alternatively, the information related to the data rate may also be the data rate R′_{data} before subcarrier modulation, in which the data rate R_{data}=2R′_{data}·R_{code}. When

$${R}_{c o d e} = \frac{1}{2 M} , {R}_{d a t a} = \frac{{{R}^{′}}_{d a t a}}{M} .$$

When the first node transmits information with PIE (pulse interval encoding), R_{data} and/or R′_{data} may be determined according to the duration of the relevant chips in the signaling transmitted by the first node.

In the reference signal block, after receiving the reference signal configuration information, the A-IoT device transmits a reference signal sequence on each antenna port according to the reference signal configuration information. For an A-IoT device that can only support simple time-domain modulation, the reference signal sequence length Lᵣₛ needs to satisfy Lᵣₛ≥Nₐₙₜ to ensure that the reference signal sequences between Nₐₙₜ antenna ports are orthogonal to each other or have low cross-correlation.

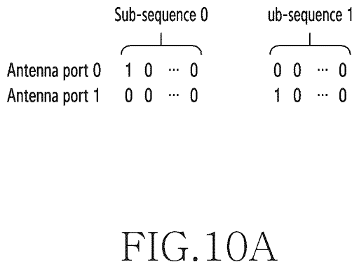

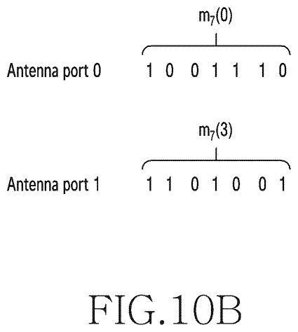

FIG. 10A illustrates a schematic diagram of a reference signal sequence according to an embodiment of the disclosure.

FIG. 10B illustrates a schematic diagram of a reference signal sequence according to an embodiment of the disclosure.

Alternatively, the reference signal sequence may be composed of Nₐₙₜ sub-sequences with the length of

$${L}_{s u b} = \frac{{L}_{r s}}{{N}_{a n t}}$$

(generally, L_{sub} is an integer greater than or equal to 2), and is related to the identification (ID) or index of the antenna port. In some embodiments, the reference signal sequence length Lᵣₛ may be an integer multiple of the antenna port number Nₐₙₜ. In other embodiments, when the reference signal sequence length Lᵣₛ is not an integer multiple of the antenna port number Nₐₙₜ, the length L_{sub} of the sub-sequence may be determined by rounding

$$\frac{{L}_{rs}}{{N}_{ant}}$$

up or down, for example. In the reference signal sequence corresponding to antenna port i∈[0, Nₐₙₜ−1], the (i+1)-th sub-sequence (for example, sub-sequence i) includes 1 reference signal ‘1’ and L_{sub}−1 reference signals ‘0’, where the reference signal ‘1’ is located at a start location of the sub-sequence, and other sub-sequences except the (i+1)-th sub-sequence is composed of L_{sub} reference signals ‘0’. This kind of reference signal sequence has a simple generation rule, which is very easy to be generated by an A-IoT device with low complexity, and well ensures the orthogonality between reference signal sequences of different antenna ports. For example, when Nₐₙₜ=2, the reference signal block is shown in FIG. 10A, where the inner product between any two rows is 0, that is,

$${S}_{i}^{T} \cdot {S}_{j} = 0 , ∀ i , j ∈ [ 0 , 1 ]$$

and i≠j. In a feasible embodiment, the length L_{sub} of the sub-sequence may also be related to at least one of a delay spread τ_{ch} of a channel (for example, the channel used for transmitting the reference signal sequence) and the duration Tᵣₛ of the reference signal. When the receiver obtains channel information through time-domain channel estimation, in order to ensure that the receiver obtains the channel information without aliasing, the duration T_{sub} of the sub-sequence in the reference signal sequence should not be less than the delay spread Ich of the channel, that is, T_{sub}=Tᵣₛ·L_{sub}≥τ_{ch}. Therefore, the length of the sub-sequence needs to satisfy

$${L}_{s u b} \geq \frac{{τ}_{c h}}{{T}_{r s}} .$$

Alternatively, the reference signal sequence may be composed of a pseudo-random sequence (e.g., a base sequence, such as an m sequence) with a length of Lᵣₛ and which is after a cyclic shift of c bits, where c is an integer greater than or equal to 0 and less than the length of the corresponding pseudo-random sequence. Similarly, in order to ensure that the receiver can obtain the channel information without aliasing, the duration of the reference signal sequence T_{seq} should not be less than Nₐₙₜ times of the channel delay spread, that is, T_{seq}=Tᵣₛ·Lᵣₛ≥Nₐₙₜ·τ_{ch}. Therefore, the length of the reference signal sequence needs to satisfy

$${L}_{r s} \geq \frac{{N}_{a n t} \cdot {τ}_{c h}}{{T}_{r s}} .$$

Further, the bit number c of the cyclic shift of the reference signal sequence is related to the ID of the antenna port: the bit number c of the cyclic shift of the reference signal sequence corresponding to an antenna port i∈[0, Nₐₙₜ−1] is

$$c = i * ⌊ \frac{{L}_{r s}}{{N}_{a n t}} ⌋ ,$$

where └·┘ means rounding down. This kind of reference signal sequence may also be generated by a simple logic circuit, which ensures low cross-correlation between reference signal sequences of different antenna ports and also has good self-correlation. For example, when Nₐₙₜ=2 and Lᵣₛ=7, the reference signal sequence on antenna port 0 may be an m sequence with a length of 7 without cyclic shift: [1 0 0 1 1 1 0], marked as m₇ (0), and the reference signal sequence on antenna port 1 may be a sequence with a cyclic shift of 3 bits for the m sequence: [1 1 0 1 0 0 1], marked as m₇ (3), referring to FIG. 10B. The inner product between any two rows is 2, that is,

$${S}_{i}^{T} \cdot {S}_{j} = 2 << {L}_{rs} , ∀ i , j ∈ [ 0 , 1 ] and i \neq j ,$$

and the inner product between each row and itself is 4, that is,

$${S}_{i}^{T} \cdot {S}_{i} = 4 , ∀ i ∈ [ 0 , 1 ] .$$

Alternatively, the above two definitions of reference signal sequence may also be described as: the reference signal sequence is obtained by cyclic shift of a root sequence (or base sequence) with the length of Lᵣₛ, and the bit number c of the cyclic shift is related to the reference signal sequence and the identification (ID) or index of the antenna port. Herein, the root sequence (or base sequence) may be composed of 1 reference signal ‘1’ and Lᵣₛ−1 reference signals ‘0’. In a feasible implementation, the reference signal ‘1’ is at the start location of the reference sequence. Alternatively, the root sequence (or base sequence) may be composed of a pseudo-random sequence with a length of Lᵣₛ (such as an m sequence).

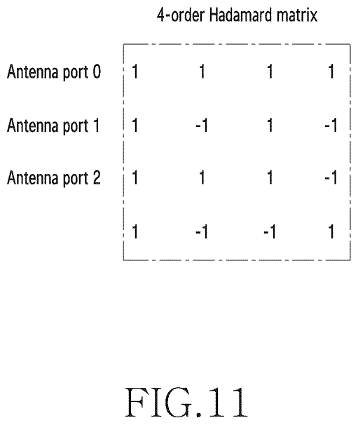

FIG. 11 illustrates a schematic diagram of a 4-order Hadamard matrix and a reference signal block according to an embodiment of the disclosure.

Alternatively, when the A-IoT device adopts BPSK modulation, the reference signal sequence consists of a total of Lᵣₛ reference signals ‘1’ (corresponding to ‘in-phase’) and reference signals ‘−1’ (corresponding to ‘anti-phase’). A feasible implementation is to select the first Nₐₙₜ rows of an Lᵣₛ Hadamard matrix as the reference signal sequence of antenna ports 0˜Nₐₙₜ−1, in which the i-th (i∈1˜Lys) row of the Lᵣₛ Hadamard matrix can be obtained by the following equation: Hᵢ=−1^{(i-1) (i-2)}. [1, −1^{(i-1) (j-1)}], j=1, 2, . . . , Lᵣₛ, where Lᵣₛ=2^{a}, and a is an integer not less than log₂ Nₐₙₜ. Because a Hadamard matrix with a fixed order is unique, Hadamard matrices with different orders can be stored in a storage unit of the A-IoT device in advance and they can be directly called from the storage unit after the A-IoT device receives a reference signal sequence length indication. This implementation method reduces the requirement of computing power for A-IoT devices to generate orthogonal reference signal sequences to the greatest extent. For example, when Nₐₙₜ=3, a=2, Lᵣₛ=4, a 4-order Hadamard matrix and the reference signal block are shown in FIG. 11, in which the inner product between any two rows is 0, that is,

$${S}_{i}^{T} \cdot {S}_{j} = 0 , ∀ i , j ∈ [ 0 , 2 ]$$

and i+j. It should be understood that the Lᵣₛ-order Hadamard matrix described above is just an example, and it may also be any other Lᵣₛ-order matrix (or square matrix) which is composed of 1 and −1 and orthogonal between any two rows, and is not limited here.

When the A-IoT device transmits signals based on backscattering modulation, the method for generating the above reference signals is as follows: adjusting the reflection coefficient of the device to 1 to transmit the reference signal ‘1’, adjusting the reflection coefficient of the device to 0 to transmit the reference signal ‘0’, and adjusting the reflection coefficient of the device to −1 to transmit the reference signal ‘−1’. Herein, the reflection coefficients 1 and 0 also correspond to ‘On’ and ‘Off’ of the OOK modulation, while the reflection coefficients 1 and −1 also correspond to ‘in-phase’ and ‘anti-phase’ of the BPSK modulation.

In this case, the reference signal sequence length indication may also be used to indicate the selection of the parameter a. This design further reduces the number of bits required for the reference signal sequence length indication, and further reduces the resource overhead of the reference signal configuration information.

The method for determining the reference signal configuration information by the A-IoT device may also be: determining the reference signal configuration information according to predefinition or a predefined configuration. Specifically, the transmitter and receiver in the A-IoT system (that is, the A-IoT device and the first node) follow the same set of reference signal configuration, including the length of the reference signal sequence, the duration of the reference signal, the pattern of the reference signal sequence, and the time-domain resource location of the reference signal sequence, etc. On this basis, the A-IoT device can directly transmit multi-antenna port reference signals according to this set of configuration, without the need for configuration by the first node by transmitting additional signaling. A feasible reference signal configuration is as follows: the duration of the reference signal is fixed as the chip duration transmitted by the A-IoT device (i.e. k=1); the length Lᵣₛ of the reference signal sequence may be selected according to the delay spread and chip duration in typical communication scenarios; and the pattern of the reference signal sequence is determined according to the modulation mode of the A-IoT device: an m sequence with a certain cyclic shift or ‘0’ and ‘1’ sub-sequences with equal length in a case of OOK modulation; and the first Nₐₙₜ rows of a Hadamard matrix in a case of BPSK modulation, and the location of reference signal sequence is between a preamble and the data signal/access signal.

Alternatively, the A-IoT device may also transmit a new multi-port reference signal according to reference signal configuration update information. The method for determining the reference signal configuration update information by the A-IoT device may be that: determining the reference signal configuration update information according to a received second signaling. The second signaling may be a second broadcast signaling on the PRDCH channel in the A-IoT system. The second broadcast signaling is other broadcast signaling (such as the QueryRep signaling and QueryAdjust signaling in the RFID system) except for the initial broadcast signaling (such as the Query signaling in the RFID system).

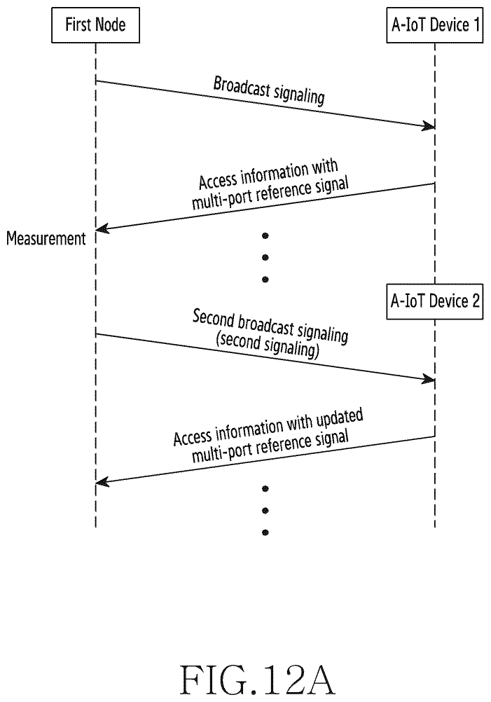

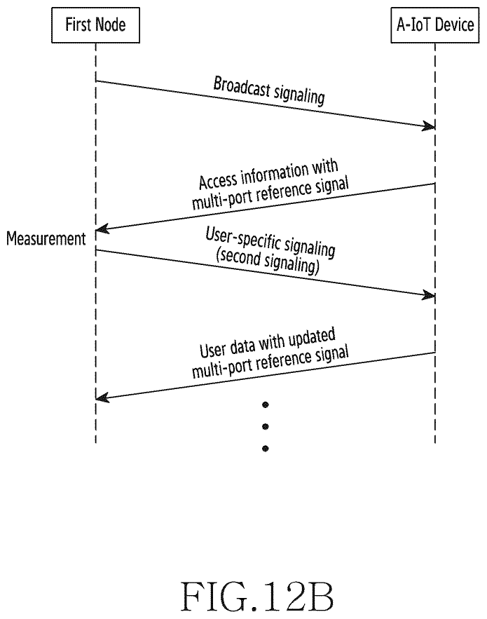

FIG. 12A illustrates a schematic diagrams of signaling exchanging between a first node and an Ambient Internet of Things (A-IoT) device according to an embodiment of the disclosure.

FIG. 12B illustrates a schematic diagrams of signaling exchanging between a first node and an Ambient Internet of Things (A-IoT) device according to an embodiment of the disclosure.

Referring to FIG. 12A, after receiving the access information/data information carrying the multi-port reference signal transmitted by the A-IoT device 1, the first node measures the received multi-port reference signal to obtain channel information, such as path loss, delay spread, etc., and then transmits the second signaling containing the reference signal configuration update information according to the measurement results, so as to configure a more suitable multi-port reference signal for the A-IoT devices within its coverage.

Alternatively, the second signaling may also be a user-specific signaling on the PRDCH channel in the A-IoT system, such as the ACK signaling in the RFID system, referring to FIG. 12B. Since the user-specific signaling can only be successfully received by a specific user, only the A-IoT device that successfully receives the signaling can update the reference signal configuration information according to the reference signal configuration update information contained in the signaling. For the A-IoT system, only after the access sequence transmitted by the A-IoT device is successfully received will the first node communicating with it transmit the user-specific signaling to it. This means that the first node can obtain the channel information according to the measurement of the multi-port reference signal in the access signal, and then configure reference signals which are more suitable for its channel for the device.

The second signaling includes at least one of the following: fourth information (e.g., reference signal sequence length update indication and/or information) related to the update and/or change value of the reference signal sequence length, fifth information (e.g., reference signal resource update indication and/or information) related to the update and/or change value of the locations of time-domain resources used for transmitting the reference signal, etc. The A-IoT device may determine the change amount of the length of the reference signal sequences transmitted on at least two antenna ports (and/or the length of the updated reference signal sequence) according to the reference signal sequence length update indication, and may also determine the change amount of the time-domain resource location (and/or the updated time-domain resource location) of the reference signal sequences transmitted on at least two antenna ports according to the reference signal resource update indication.

Alternatively, when the reference signal resource indication is used to indicate a resource set for the A-IoT device to transmit the reference signal sequence (or reference signal block), the reference signal resource update indication may indicate an updated resource set for the A-IoT device with the same bit length as the reference signal resource indication. For example, if the reference signal resource indication in the first signaling is [0 0], it means that the A-IoT device needs to transmit a reference signal sequence on resource set 0, and when the A-IoT device receives a reference signal resource update indication [1 0], it updates the resource set where it will transmit the reference signal sequence to resource set 2.

Alternatively, when the reference signal resource indication is used to indicate a density or distance of the reference signal sequence, the reference signal resource update indication may be used to indicate the change amount Δρ or Δd of the density or distance of the reference signal sequence. For example, when the reference signal resource update indication is bit 1, it may mean that the reference signal sequence density or distance increases by 1, that is, Δp=1 or Δd=1; and when the reference signal resource update indication is bit 0, it may mean that the reference signal sequence density or distance is reduced by 1, that is, Δp=−1 or Δd=−1. If the reference signal sequence density before updating is p=2, and the reference signal resource update indication is bit 1, then the updated density is p′=p+Δp=3, that is, one reference signal sequence is transmitted every three time-domain symbols.

Alternatively, when the reference signal sequence length indication is used to indicate the length Lᵣₛ of the reference signal sequence transmitted by the A-IoT device, the reference signal sequence length update indication may be used to indicate the change amount of Lys. For example, when the reference signal sequence length update indication is [1 1], it may indicate that the reference signal sequence length increases by 3, that is, ΔLᵣₛ=3, and if the reference signal sequence length before updating is Lᵣₛ=3, it will be

$${L}_{rs}^{′} = {L}_{rs} + Δ {L}_{rs} = 6$$

after the updating.

Alternatively, when the reference signal sequence length indication is used to indicate an order of a Hadamard matrix related to the reference signal sequence transmitted by the A-IoT device, the reference signal sequence length update indication can be used to indicate the change amount of the order. If the Hadamard matrix related to the reference signal sequence transmitted by the A-IoT device before updating is 2^{a}, then when the reference signal sequence length update indication is bit 1, it means that the order of the Hadamard matrix becomes 2^{a+1}; and when the reference signal sequence length update indication is bit 0, it means that the order of the Hadamard matrix becomes 2^{a-1}.

After receiving the multi-antenna port reference signals transmitted by the A-IoT device, the method for channel estimation by the first node communicating with the A-IoT device may be as follows: extracting the reference signal sequences from the time-domain resources corresponding to the reference signal resource indication; and performing time-domain channel estimation according to the reference signal sequence.

Next, an implementation method for time-domain channel estimation is illustrated by taking 2 antenna ports as an example. Assuming that the reference signal sequences transmitted on antenna ports 0 and 1 are p₀ and p₁ respectively, and their lengths are all equal to Lᵣₓ, and h₀ and h₁ are impulse responses of the channels through which p₀ and p₁ respectively pass, and their lengths are all equal to L_{ch}, then after p₀ and p₁ respectively pass through the channels h₀ and h₁, the synthesized reference signal sequence r received by the first node is represented as the following Equation 1:

$$\begin{matrix}r = {r}_{0} + {r}_{1} + n \\ = {p}_{0} * [ \begin{matrix}{h}_{0} \\ {0}_{( {L}_{rs} - {L}_{ch} ) \times 1}\end{matrix} ] + {p}_{1} * [ \begin{matrix}{h}_{1} \\ {0}_{( {L}_{rs} - {L}_{ch} ) \times 1}\end{matrix} ] + n \\ = {P}_{0} [ \begin{matrix}{h}_{0} \\ {0}_{( {L}_{rs} - {L}_{ch} ) \times 1}\end{matrix} ] + {P}_{1} [ \begin{matrix}{h}_{1} \\ {0}_{( {L}_{rs} - {L}_{ch} ) \times 1}\end{matrix} ] + n\end{matrix} \qquad Equation 1$$

Where r₀ is the reference signal sequence transmitted by the A-IoT device through the antenna port 0 received by the first node, r₁ is the reference signal sequence transmitted by the A-IoT device through the antenna port 1 received by the first node, * represents a convolution operation, P₀ and P1 represent a [symbol] (L [symbol] ᵣₛ+L_{ch}−1)×L_{ch} dimensional linear convolution matrix composed of p₀ and p₁ respectively, and n is [symbol] (L [symbol] ᵣₛ+L_{ch}−1)×1 dimensional additive Gaussian white noise. The following Equation 2 can be obtained by left multiplying the received reference signal by

$$Equation 2$$

$$\begin{matrix}[ \begin{matrix} & {L}_{ch - 1} \\ {I}_{{L}_{rs}} & {0}_{{L}_{rs} - {L}_{ch}}\end{matrix} ] \text{:} y = Φ {P}_{0} [ \begin{matrix}{h}_{0} \\ {0}_{( {L}_{rs} - {L}_{ch} ) \times 1}\end{matrix} ] + Φ {P}_{1} [ \begin{matrix}{h}_{1} \\ {0}_{( {L}_{rs} - {L}_{ch} ) \times 1}\end{matrix} ] + Φ n \\ = {C}_{0} [ \begin{matrix}{h}_{0} \\ {0}_{( {L}_{rs} - {L}_{ch} ) \times 1}\end{matrix} ] + {C}_{1} [ \begin{matrix}{h}_{1} \\ {0}_{( {L}_{rs} - {L}_{ch} ) \times 1}\end{matrix} ] + Φ n\end{matrix}$$

Where Iₐ and 0ₐ are a×a dimensional unit matrix and a×a dimensional zero matrix respectively, and C₀ and C₁ represent a Lᵣₛ×Lᵣₛ dimensional circular convolution matrix composed of p₀ and p₁ respectively. Then the estimate h̅₁ for h₁ and the estimate h̅₂ for h₂ can be obtained by left multiplying y

$${C}_{0}^{H} ,$$

that is:

$$\overline{h} = {C}_{0}^{H} y = {C}_{0}^{H} {C}_{0} [ \begin{matrix}{h}_{0} \\ {0}_{( {L}_{rs} - {L}_{ch} ) \times 1}\end{matrix} ] + {C}_{0}^{H} {C}_{1} [ \begin{matrix}{h}_{0} \\ {0}_{( {L}_{rs} - {L}_{ch} ) \times 1}\end{matrix} ] + {C}_{0}^{H} Φ n \qquad Equation 3$$

When the reference signal sequences are orthogonal to each other or have low cross-correlation, the above equation may be further expressed as

$$\overline{h} = {I}_{{L}_{rs}} [ \begin{matrix}{h}_{0} \\ {0}_{( {L}_{rs} - {L}_{ch} ) \times 1}\end{matrix} ] + {\overline{I}}_{{L}_{rs}} [ \begin{matrix}{h}_{1} \\ {0}_{( {L}_{rs} - {L}_{ch} ) \times 1}\end{matrix} ] + {C}_{0}^{H} Φ n \qquad Equation 4$$

Where Ī_{L}_{_{RS}} is a matrix after performing a cyclic shift of c bits on

$${T}_{{L}_{rs}} .$$

Then the first L_{ch} rows of h̅ is h̅₀, and the [symbol] (L [symbol] _{sub}+1)-th row to the (L_{sub}+L_{ch})-th row (or the

$$( ⌊ \frac{{L}_{rs}}{{N}_{ant}} ⌋ + 1 )$$

-th row to the

$$( ⌊ \frac{{L}_{rs}}{{N}_{ant}} ⌋ + {L}_{ch} ) .$$

-th row) is h̅₁.

It should be understood that, depending on the application scenarios, the various example aspects, methods, steps, processes, etc. shown in the attached drawings can be combined and implemented in any way, and are not limited herein.

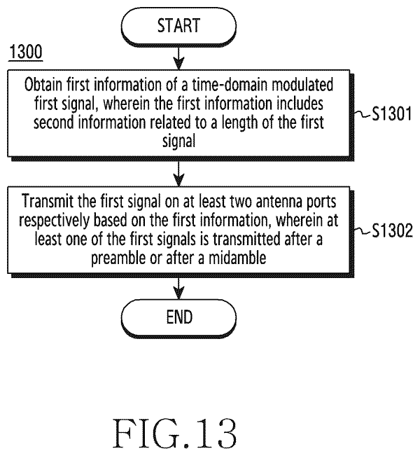

FIG. 13 shows a flowchart of a method 1300 performed by a terminal in a wireless communication system according to an embodiment of the disclosure.

Referring to FIG. 13, a method 1300 performed by a terminal in a wireless communication system according to an embodiment of the disclosure may include: in operation S1301, obtaining first information of a time-domain modulated first signal, wherein the first information includes second information related to a length of the first signal; and in operation S1302, transmitting the first signal on at least two antenna ports respectively based on the first information. In some implementations, at least one of the first signals is transmitted after a preamble or after a midamble.

According to an embodiment of the disclosure, the first information further includes third information related to locations of time-domain resources for transmitting the first signal.

According to an embodiment of the disclosure, the second information includes the number of time units occupied by the first signal.

According to an embodiment of the disclosure, the obtaining first information of a time-domain modulated first signal includes: receiving first signaling including the first information from a first node, wherein the first signaling includes at least one of: broadcast signaling related to Ambient Internet of Things (A-IoT) and user-specific signaling related to A-IoT.

According to an embodiment of the disclosure, the third information includes locations of time units occupied by the first signal.

According to an embodiment of the disclosure, the third information includes seventh information associated with a periodicity of the first signal.

According to an embodiment of the disclosure, the second information includes a value k, and wherein a sequence length of the first signal is equal to 2^{k}, where k is an integer greater than 0.

According to an embodiment of the disclosure, the first information further includes eighth information related to a code rate and ninth information related to a data rate, and wherein the method further includes determining a duration of a time unit occupied by the first signal based on the eighth information and the ninth information.

According to an embodiment of the disclosure, the first signal is a first signal sequence; and wherein a length of the first signal sequence is equal to the number of time units occupied by the first signal and is greater than or equal to the number of ports of the at least two antenna ports.

According to an embodiment of the disclosure, the first signal is a first signal sequence; and wherein the first signal sequence on each antenna port includes Nₐₙₜ sub-sequences, where Nₐₙₜ is the number of ports of the at least two antenna ports, and the first signal sequence on each antenna port is associated with an index of the antenna port.

According to an embodiment of the disclosure, a length of each sub-sequence is

$${L}_{sub} = \frac{{L}_{rs}}{{N}_{ant}} ,$$

where Lᵣₛ is a length of the first signal sequence, and wherein the first signal sequence on each antenna port being associated with an index of the antenna port includes: for antenna port i, i∈[0, Nₐₙₜ−1]: a sub-sequence i includes one 1 and L_{sub}−1 zeros, and the 1 is located at a start location of the sub-sequence i; and other sub-sequences except the sub-sequence i include L_{sub} zeros.

According to an embodiment of the disclosure, the first signal is a first signal sequence; and wherein the first signal sequence on each antenna port includes a pseudo-random sequence after cyclic shifting of a base sequence, wherein a bit number of the cyclic shifting is associated with an index of the antenna port.

According to an embodiment of the disclosure, the first signal is a first signal sequence; wherein the first signal sequence includes the first Nₐₙₜ rows of an Lᵣₛ-order square matrix, where Lᵣₛ is a length of the first signal sequence and Nₐₙₜ is the number of ports of the at least two antenna ports; and wherein the Lᵣₛ-order square matrix consists of 1 and −1, and any two rows of the Lᵣₛ-order square matrix are orthogonal.

According to an embodiment of the disclosure, the method further includes receiving second signaling including update information of the first signal from a first node, wherein the update information includes at least one of fourth information related to a change value of the number of time units occupied by the first signal and fifth information related to a change value of locations of time-domain resources for transmitting the first signal; and transmitting the first signal on the at least two antenna ports respectively based on the update information.

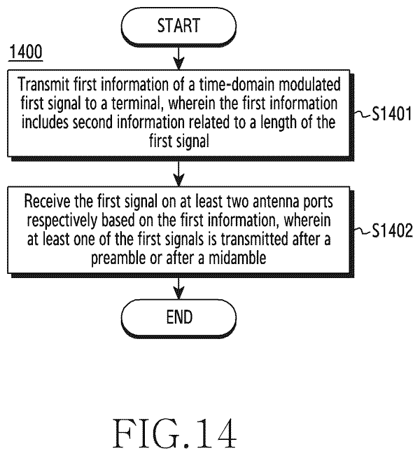

FIG. 14 shows a flowchart of a method 1400 performed by a first node in a wireless communication system according to an embodiment of the disclosure.

Referring to FIG. 14, a method 1400 performed by a first node in a wireless communication system according to an embodiment of the disclosure may include: in operation S1401, transmitting first information of a time-domain modulated first signal to a terminal, wherein the first information includes second information related to a length of the first signal; and in operation S1402, receiving the first signal on at least two antenna ports respectively based on the first information. In some implementations, at least one of the first signals is transmitted after a preamble or after a midamble.

According to an embodiment of the disclosure, the first information further includes third information related to locations of time-domain resources for transmitting the first signal.

According to an embodiment of the disclosure, the second information includes the number of time units occupied by the first signal.

According to an embodiment of the disclosure, the transmitting first information of a time-domain modulated first signal to a terminal includes: transmitting first signaling including the first information to the terminal, wherein the first signaling includes at least one of: broadcast signaling related to Ambient Internet of Things (A-IoT) and user-specific signaling related to A-IoT.

According to an embodiment of the disclosure, the third information includes locations of time units occupied by the first signal.

According to an embodiment of the disclosure, the third information includes seventh information associated with a periodicity of the first signal.

According to an embodiment of the disclosure, the second information includes a value k, and wherein a sequence length of the first signal is equal to 2^{k}, where k is an integer greater than 0.

According to an embodiment of the disclosure, the first information further includes eighth information related to a code rate and ninth information related to a data rate, and wherein the method further includes determining a duration of a time unit occupied by the first signal based on the eighth information and the ninth information.

According to an embodiment of the disclosure, the first signal is a first signal sequence; and wherein a length of the first signal sequence is equal to the number of time units included in the first signal and is greater than or equal to the number of ports of the at least two antenna ports.

According to an embodiment of the disclosure, the first signal is a first signal sequence; and wherein the first signal sequence on each antenna port includes Nₐₙₜ sub-sequences, where Nₐₙₜ is the number of ports of the at least two antenna ports, and the first signal sequence on each antenna port is associated with an index of the antenna port.

According to an embodiment of the disclosure, a length of each sub-sequence is

$${L}_{sub} = \frac{{L}_{rs}}{{N}_{ant}} ,$$

where Lᵣₛ is a length of the first signal sequence, and wherein the first signal sequence on each antenna port being associated with an index of the antenna port includes: for antenna port i, i∈[0, Nₐₙₜ−1]: a sub-sequence i includes one 1 and L_{sub}−1 zeros, and the 1 is located at a start location of the sub-sequence i; and other sub-sequences except the sub-sequence i include L_{sub} Zeros.

According to an embodiment of the disclosure, the first signal is a first signal sequence; and wherein the first signal sequence on each antenna port includes a pseudo-random sequence after cyclic shifting of a base sequence, wherein a bit number of the cyclic shifting is associated with an index of the antenna port.

According to an embodiment of the disclosure, the first signal is a first signal sequence; wherein the first signal sequence includes the first Nₐₙₜ rows of an Lᵣₛ-order square matrix, where Lᵣₛ is a length of the first signal sequence and Nₐₙₜ is the number of ports of the at least two antenna ports; and wherein the Lᵣₛ-order square matrix consists of 1 and −1, and any two rows of the Lᵣₛ-order square matrix are orthogonal.

According to an embodiment of the disclosure, the method further includes transmitting second signaling including update information of the first signal to the terminal, wherein the update information includes at least one of fourth information related to a change value of the number of time units included in the first signal and fifth information related to a change value of locations of time-domain resources for transmitting the first signal; and receiving the first signal on the at least two antenna ports respectively based on the update information.

It should be understood that methods 1300, 1400, etc. according to an embodiment of the disclosure may further include any method or step described in connection with various examples, aspects, drawings, etc. of the disclosure.

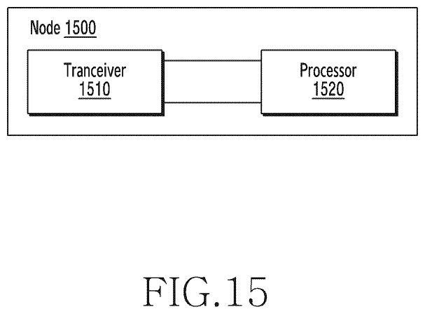

FIG. 15 illustrates a schematic diagram of a node 1500 according to an embodiment of the disclosure.

Referring to FIG. 15, a node 1500 (e.g., any node as described herein, such as a first node) according to an embodiment of the disclosure may include a transceiver 1510 and a processor 1520. The transceiver 1510 may be configured to transmit and receive signals. The processor 1520 may be coupled to the transceiver 1510 and may be configured to (e.g., control the transceiver 1510 to) perform a method performed by any node in a wireless communication system according to an embodiment of the disclosure.

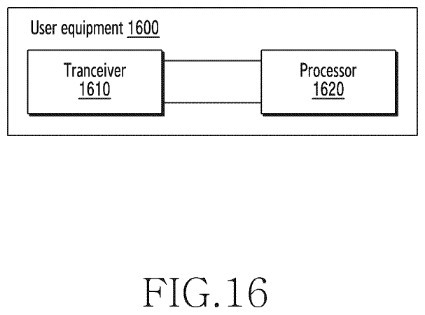

FIG. 16 illustrates a schematic diagram of a user equipment 1600 according to an embodiment of the disclosure.

Referring to FIG. 16, a user equipment 1600 according to an embodiment of the disclosure may include a transceiver 1610 and a processor 1620. The transceiver 1610 may be configured to transmit and receive signals. The processor 1620 may be coupled to the transceiver 1610 and may be configured to (e.g., control the transceiver 1610 to) perform a method performed by a user equipment (UE) in a wireless communication system according to an embodiment of the disclosure. In the disclosure, a processor may also be referred to as a controller. In the disclosure, a node may also be referred to as a node device.

Embodiments of the disclosure also provide a computer-readable medium having stored thereon computer-readable instructions, which, when executed by a processor, can be used to implement any method according to an embodiment of the disclosure.

Various embodiments of the disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disc read-only memory (CD-ROM), magnetic tape, floppy disk, optical data storage device, carrier (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the disclosure can be easily explained by those skilled in the art to which embodiments of the disclosure are applied.

It will be understood that embodiments of the disclosure may be implemented in the form of hardware, software, or a combination of hardware and software. The software may be stored as program indications or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital versatile disc (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with indications for implementing embodiments of the disclosure. The disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the disclosure suitably includes its equivalents.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
obtaining first information of a first signal, wherein the first signal is modulated in a time-domain, and wherein the first information includes second information related to a length of the first signal; and
transmitting the first signal on at least two antenna ports respectively based on the first information,
wherein the first signal is transmitted after a preamble or after a midamble.

2. The method of claim 1,
wherein the first information further includes third information related to locations of time-domain resources for transmitting the first signal, and
wherein the second information includes a number of time units occupied by the first signal.

3. The method of claim 1,
wherein the obtaining of the first information of the first signal comprises:
receiving first signaling including the first information from a first node, and
wherein the first signaling includes at least one of broadcast signaling related to ambient Internet of things (A-IoT) or user-specific signaling related to A-IoT.

4. The method of claim 2, wherein the third information includes locations of time units occupied by the first signal and seventh information associated with a periodicity of the first signal.

5. The method of claim 1,
wherein the second information includes a value k, and
wherein a sequence length of the first signal is equal to 2^{k}, where k is an integer greater than 0.

6. The method of claim 1, further comprising:
determining a duration of a time unit occupied by the first signal based on eighth information related to a code rate and ninth information related to a data rate,
wherein the eighth information related to the code rate and the ninth information related to the data rate are included in the first information.

7. The method of claim 1,
wherein the first signal is a first signal sequence, and
wherein a length of the first signal sequence is equal to a number of time units occupied by the first signal and is greater than or equal to a number of ports of the at least two antenna ports.

8. The method of claim 1,
wherein the first signal is a first signal sequence,
wherein the first signal sequence on each antenna port includes Nₐₙₜ sub-sequences, where Nₐₙₜ is a number of ports of the at least two antenna ports, and
wherein the first signal sequence on each antenna port is associated with an index of the antenna port.

9. The method of claim 7,
wherein a length of each sub-sequence is
$${L}_{sub} = \frac{{L}_{rs}}{{N}_{ant}} ,$$
where Lᵣₛ is a length of the first signal sequence, and
wherein the first signal sequence on each antenna port being associated with an index of the antenna port includes:
for antenna port i, i∈[0, Nₐₙₜ−1]:
a sub-sequence i includes one 1 and L_{sub}−1 zeros, and the 1 is located at a start location of the sub-sequence i, and
other sub-sequences except the sub-sequence i include L_{sub} zeros.

10. The method of claim 1,
wherein the first signal is a first signal sequence,
wherein the first signal sequence on each antenna port includes a pseudo-random sequence after cyclic shifting of a base sequence, and
wherein a bit number of the cyclic shifting is associated with an index of the antenna port.

11. The method of claim 1,
wherein the first signal is a first signal sequence,
wherein the first signal sequence includes first Nₐₙₜ rows of an Lᵣₛ-order square matrix, where Lᵣₛ is a length of the first signal sequence and Nₐₙₜ is a number of ports of the at least two antenna ports, and
wherein the Lᵣₛ-order square matrix consists of 1 and −1, and any two rows of the Lᵣₛ-order square matrix are orthogonal.

12. The method of claim 1, further comprising:
receiving second signaling including update information of the first signal from a first node, wherein the update information includes at least one of fourth information related to a change value of a number of time units occupied by the first signal or fifth information related to a change value of locations of time-domain resources for transmitting the first signal; and
transmitting the first signal on the at least two antenna ports respectively based on the update information.

13. A method performed by a first node in a wireless communication system, the method comprising:
transmitting first information of a first signal to a user equipment (UE), wherein the first signal is modulated in a time-domain, and wherein the first information includes second information related to a length of the first signal; and
receiving the first signal on at least two antenna ports respectively based on the first information,
wherein at least one of the first signals is transmitted after a preamble or after a midamble.

14. The method of claim 13,
wherein the first information further includes third information related to locations of time-domain resources for transmitting the first signal, and
wherein the second information includes a number of time units occupied by the first signal.

15. The method of claim 13,
wherein the transmitting of the first information comprises transmitting first signaling including the first information to the UE, and
wherein the first signaling includes at least one of broadcast signaling related to Ambient Internet of Things (A-IoT) or user-specific signaling related to A-IoT.

16. The method of claim 13,
wherein the second information includes a value k, and
wherein a sequence length of the first signal is equal to 2^{k}, where k is an integer greater than 0.

17. The method of claim 13,
wherein the first signal is a first signal sequence,
wherein the first signal sequence on each antenna port includes Nₐₙₜ sub-sequences, where Nₐₙₜ is a number of ports of the at least two antenna ports, and
wherein the first signal sequence on each antenna port is associated with an index of the antenna port.

18. The method of claim 13, further comprising:
transmitting second signaling including update information of the first signal to the UE, wherein the update information includes at least one of fourth information related to a change value of a number of time units occupied by the first signal or fifth information related to a change value of locations of time-domain resources for transmitting the first signal; and
receiving the first signal on the at least two antenna ports respectively based on the update information.

19. A user equipment (UE) in a wireless communication system, the UE comprising:
a transceiver configured to transmit and receive signals; and
a controller coupled with the transceiver and configured to:
obtain first information of a first signal, wherein the first signal is modulated in a time-domain, and wherein the first information includes second information related to a length of the first signal, and
transmit the first signal on at least two antenna ports respectively based on the first information,
wherein the first signal is transmitted after a preamble or after a midamble.

20. A first node in a wireless communication system, the first node comprising:
a transceiver configured to transmit and receive signals; and
a controller coupled with the transceiver and configured to:
transmit first information of a first signal to a user equipment (UE), wherein the first signal is modulated in a time-domain, and wherein the first information includes second information related to a length of the first signal, and
receive the first signal on at least two antenna ports respectively based on the first information,
wherein at least one of the first signals is transmitted after a preamble or after a midamble.
